(19) United States
(12) Patent Application Publication
(10) Pub. No.: US 2026/0343461 A1
(43) Pub. Date: Oct. 29, 2026

(54) SYSTEMS AND METHODS FOR INTELLIGENT ONBOARDING PROCEDURES FOR A UNIFIED INTERNET OF THINGS CONFIGURATION AND REPORTING PLATFORM

(71) Applicant: Verizon Patent and Licensing Inc., Basking Ridge, NJ (US)

(72) Inventors: Chandrababu Naidu Kamani, McKinney, TX (US); Wujun Qie, Needham, MA (US); Shweta Agarwal, Franklin, MA (US); Adriana M. Rincon, Land O' Lakes, FL (US); Srirama R. Kalidindi, Flower Mound, TX (US); Jaykishan Tiwari, Irving, TX (US); Pratod V. Kasbekar, Manalapan, NJ (US); Prabhjot Kaur, Sharon, MA (US); Yagiz Onat Yazir, Hollis, NH (US); Saurabh Bhatnagar, Westborough, MA (US)

(73) Assignee: Verizon Patent and Licensing Inc., Basking Ridge, NJ (US)

(21) Appl. No.: 19/192,305

(22) Filed: Apr. 28, 2025

(51) Int. Cl. H04W 60/00; H04W 12/06; H04W 12/73

(52) U.S. Cl. CPC H04W 60/005; H04W 12/06; H04W 12/73

(57) ABSTRACT

A system described herein may register a first and second Internet of Things (“IoT”) gateways that provide IoT device connectivity via first and second access technologies, respectively. The system may maintain information specifying a plurality of different onboarding procedures for different access technologies, and process onboarding requests associated with different respective IoT devices, associated with respective IoT gateways. For example, the system may determine onboarding requests associated with the first IoT gateway should be handled by performing a first onboarding procedure, and that onboarding requests associated with the second IoT gateway should be handled by performing a second onboarding procedure, based on the respective access technologies implemented by the IoT gateways. The system may perform the different onboarding procedures to onboard the first and second IoT devices; receive, based on onboarding the first and second IoT devices, IoT uplink information from the first and second IoT devices.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. IoT devices may include, for example, sensors (e.g., temperature sensors, motion sensors, water sensors, or the like), smart home devices, or the like. Planning, deploying, and managing a complete IoT infrastructure faces challenges such as disparate IoT device types (e.g., different manufacturers, models, hardware types, etc.), a lack of real time (or near-real time) insights into IoT device operational health, uncertainty over maximizing future scalability, requirements for technical expertise in integrating IoT devices with existing infrastructure, security concerns, among other challenges.

### BRIEF DESCRIPTION OF THE DRAWINGS

FIG. 1 illustrates an example overview of one or more embodiments described herein;

FIGS. 2-4 illustrate example deployments of different types of IoT devices and/or gateways that utilize different communication technologies, in accordance with some embodiments;

FIG. 5 illustrates an example of different domains to which different sets of IoT devices may belong, in accordance with some embodiments;

FIG. 6 illustrates an example of accessing uplink and/or downlink information associated with IoT devices of a domain, in accordance with some embodiments;

FIG. 7 illustrates an example of IoT device-specific information that may be used to present uplink and/or downlink information associated with different IoT device types via a unified system, in accordance with some embodiments;

FIG. 8 illustrates an example of registering one or more IoT gateways, in accordance with some embodiments;

FIG. 9 illustrates an example overview of selecting an IoT onboarding procedure based on an IoT access technology associated with a given IoT device, in accordance with some embodiments;

FIGS. 10-12 illustrate different example types of IoT onboarding procedures, in accordance with some embodiments;

FIG. 13 illustrates an example process for selectively performing different IoT onboarding processes for IoT devices that communicate using different access technologies, in accordance with some embodiments;

FIGS. 14 and 15 illustrate example environments in which one or more embodiments, described herein, may be implemented;

FIG. 16 illustrates an example arrangement of a radio access network (“RAN”), in accordance with some embodiments; and

FIG. 17 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein provide a unified IoT infrastructure that provides for a seamless onboarding of a variety of different types of IoT devices, as well as a single point of access for configuration and reporting for multiple different IoT devices with varying characteristics. Such characteristics may include, for example, different manufacturers and/or models of IoT devices, different IoT device types or categories (e.g., temperature sensors, motion sensors, water sensors, etc.), IoT devices with different communication technologies or protocols (e.g., wireless technologies or protocols such as Bluetooth® Low Energy (“BLE”®) or Long Range Wide Area Network (“LoRaWAN”®), or wired technologies or protocols such as IO-Link®), or other differentiating characteristics. In one example, some IoT devices may be rated for various types of interior use (e.g., within warehouses, industrial facilities, or the like), while other IoT devices may be rated for rugged exterior use (e.g., in agricultural or other outdoor applications). As noted above, implementing an environment or infrastructure that incorporates a wide variety of IoT devices with their differing characteristics may pose technical challenges, logistical challenges, and/or other challenges. The unified IoT infrastructure described herein solves such challenges, thus allowing the seamless and easy deployment, configuration, and monitoring of a variety of different types of IoT devices (e.g., in a manner that is “agnostic” to the differing characteristics of the IoT devices) via a single, easy to access interface.

Embodiments described herein further provide for different onboarding procedures to be used, such as different onboarding procedures for IoT devices using different communication technologies or protocols. For example, in one example embodiment, a first onboarding procedure may be provided for IoT devices using a LoRaWAN communication technology, a second onboarding procedure may be provided for IoT devices using a BLE communication technology, and a third onboarding procedure may be provided for IoT devices using an IO-Link communication technology. The different onboarding procedures may be based on different characteristics associated with the different communication technologies.

For example, LoRaWAN gateways may be unable to feasibly perform automatic discovery of new devices (e.g., LoRaWAN IoT devices) due to factors such as congestion of LoRaWAN bands, interference, or the like. For example, heavy LoRaWAN band congestion, interference, etc. may render it burdensome in terms of processing resources or otherwise unfeasible to identify discovery signals, broadcasts, etc. from new (e.g., not yet connected) LoRaWAN IoT devices. Additionally, or alternatively, LoRaWAN networks may be associated with security protocols that performing an automatic discovery of LoRaWAN devices, such as LoRaWAN IoT devices. Embodiments described herein provide for the targeted discovery of LoRaWAN IoT devices (e.g., via LoRaWAN bands). For example, an entity that deploys, manages, etc. a set of LoRaWAN IoT devices may communicate with a via a Unified IoT Configuration and Reporting Platform (“UICRP”) to establish LoRaWAN connectivity with such LoRaWAN IoT devices. In this manner, such entity need not configure specific LoRaWAN gateways or otherwise need to specifically configure connectivity between LoRaWAN IoT devices and gateways, as the UICRP may manage the registration of LoRaWAN IoT gateways and facilitate the establishment of connectivity with LoRaWAN IoT devices, as discussed herein.

In one example embodiment, an onboarding procedure for BLE IoT devices may include an automatic pairing or connection of BLE IoT devices to a BLE gateway. In some embodiments, the BLE IoT device onboarding procedure may further include notifying a user or other entity that the onboarding procedure has commenced with respect to a new BLE IoT device. In some embodiments, the onboarding procedure may include obtaining user approval, authorization, authentication, or the like prior to authorizing or finalizing the connection of the BLE IoT device to the BLE gateway. Additionally, or alternatively, the onboarding procedure may include obtaining user approval, authorization, authentication, or the like prior to accepting (e.g., not rejecting, quarantining, dropping, etc.) uplink traffic from the BLE IoT device. In some scenarios, BLE IoT gateways may be able to perform new discovery of BLE IoT devices.

In some scenarios, the communication range of BLE technologies may be significantly less (e.g., smaller) than the communication range of LoRaWAN technologies. Due to the smaller communication range, the likelihood of congestion or interference for BLE technologies may be significantly lower than for LoRaWAN technologies. As such, it may be more feasible for BLE gateways to perform automatic discovery of BLE IoT devices, than it is for LoRaWAN gateways to perform automatic discovery of LoRaWAN IoT devices. For example, BLE gateways may broadcast discovery information on a regular or periodic basis so that BLE IoT devices can detect and connect to BLE gateways, while LoRaWAN gateways do not typically allow for auto-discovery in this manner due to factors discussed above.

In one embodiment, an onboarding procedure for an IO-Link gateway may include a fully automatic onboarding procedure. For example, as discussed below, the fully automatic onboarding procedure may require no user intervention, input, or feedback, after an IO-Link IoT device is connected (e.g., physically connected via an interface cable such as a 4-pin or 8-pin M 12 connector) to an IO-Link gateway. For example, the automatic onboarding procedure may be performed with an assumption that an authorized entity, which has physical access to a respective IO-Link gateway, has intended to communicatively couple an IO-Link IoT device to the UICRP of some embodiments. As such, further confirmation, authorization, or authentication may not be necessary. In this manner, various techniques are provided for IoT devices implementing varying types of access technologies, thus ultimately enhancing the functionality of the IoT ecosystem of some embodiments and reducing the complexity for end users.

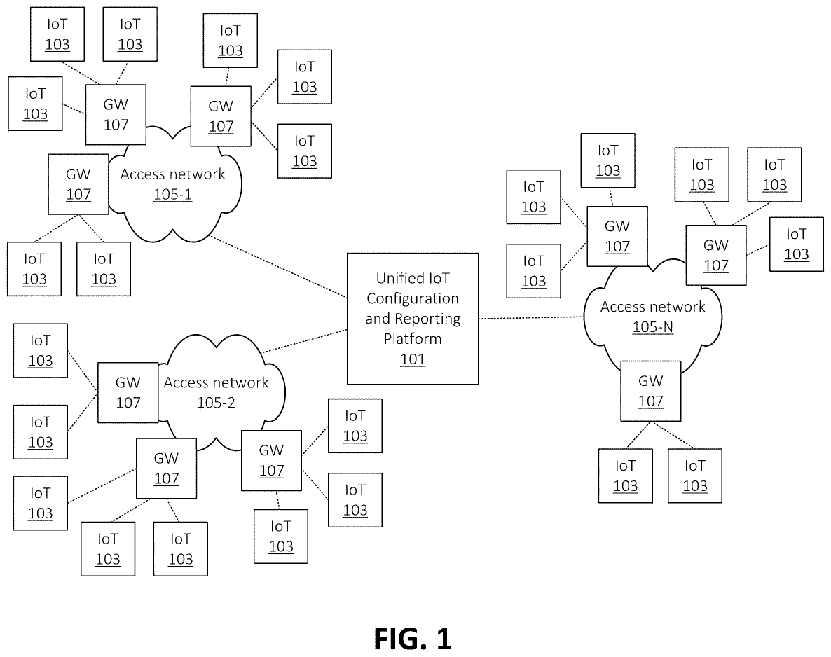

As shown in FIG. 1, UICRP 101 of some embodiments may be communicatively coupled to a variety of different IoT devices 103 (represented in the figures as, for example, “IoT 103”). IoT devices 103 may include or may be communicatively coupled to devices such as sensors, smart home appliances, alarms, and/or other types of devices. In one example, a particular IoT device 103 may include a temperature sensor that measures temperature (e.g., ambient air temperature at a location in which IoT device 103 is installed). In another example, IoT device 103 may include a water sensor that detects the presence of liquid (e.g., which may be used in applications such as plumbing leak detection in a smart home environment). In another example, IoT device 103 may include a humidity sensor that determines a measure of relative humidity of ambient air. In yet another example, IoT device 103 may include a home security sensor, such as a glass break sensor, a door or window opening sensor, a motion sensor, or the like. In another example, IoT device 103 may include an air particulate and/or gas sensor, such as a smoke detector, a carbon monoxide detector, an air quality sensor, or the like. As another example, IoT devices 103 may include Heating, Ventilation, and Air Conditioning (“HVAC”) sensors, such as HVAC airflow sensors, HVAC control board diagnostic sensors, or the like. In some embodiments, IoT devices 103 may include relatively complex sensors used in industrial environments such as electric current sensors, voltage monitoring sensors, liquid level monitoring through ultrasonic sensors, or other industrial sensors. In some embodiments, IoT devices 103 may include vibration sensors, pressure sensors, accelerometers, tracking devices, and/or other suitable types of sensors.

IoT devices 103 may generate and output monitoring information and/or other suitable types of information (referred to herein as “uplink information”). For example, a temperature sensor may periodically (e.g., every minute, every 15 minutes, hourly, daily, etc.) output a temperature reading, such as a current temperature, an average temperature over a given timeframe, a maximum temperature over a given timeframe, etc. As another example, the temperature sensor may output alerts (e.g., non-scheduled alerts, or “push” alerts) based on detecting the occurrence of particular conditions, such as a temperate rising greater than or falling lower than a given threshold temperature.

In some embodiments, IoT devices 103 and UICRP 101 may implement one or more application programming interfaces (“APIs”), software development kits (“SDKs”), frameworks, applications, etc. via which IoT devices 103 and UICRP 101 are configured to communicate with each other (e.g., using particular Internet Protocol (“IP”) discovery techniques or other suitable techniques). For example, IoT device 103 may implement a “client-side” application or API, where UICRP 101 may implement a “server-side” application or API. As another example, IoT devices 103 may be configured to communicate with some other device or system (e.g., an application server, a third-party IoT management platform, or the like), where such other device or system is configured to communicate with UICRP 101. Thus while examples described herein are provided in the context of communications between IoT devices 103 and UICRP 101 (e.g., via respective gateways 107), similar concepts may apply in environments where one or more other devices or systems are involved in communications between IoT devices 103 and UICRP 101.

In some embodiments, IoT devices 103 may output uplink information to UICRP 101 via one or more networks or devices, as discussed herein. For example, communication pathways between UICRP 101 and various IoT devices 103 may include or traverse one or more networks or devices, such as access networks 105 (e.g., access networks 105-1, 105-2, and 105-N) and/or one or more gateways 107. Access networks 105 may be implemented using various different connectivity technologies in order to wirelessly connect to respective IoT devices 103, including wireless technologies such as LoRaWAN, BLE, Wi-Fi, or the like. As another example, access networks 105 may be implemented using wired technologies such as IO-Link, Ethernet, Universal Serial Bus (“USB”), or the like. In general, IoT devices 103 may include circuitry and/or logic to communicate with gateways 107 (e.g., using short-range wireless communication technologies and/or wired technologies such as LoRaWAN, BLE, or IO-Link), but may lack circuitry and/or logic to communicate via longer range networks (e.g., using longer range wireless communication technologies such as LTE or 5G). On the other hand, access networks 105 may implement communication technologies to communicate with IoT devices 103 (e.g., via relatively short-range wireless communications such as BLE, LoRaWAN, or Wi-Fi, and/or via wired connections), and may further implement communication technologies to communicate with UICRP 101 via one or more other networks. In some embodiments, one gateway 107 may implement one access network 105. In some embodiments, multiple gateways 107 may implement a given access network 105 (e.g., gateways 107 may implement a “mesh” deployment or other suitable type of deployment).

In this manner, UICRP 101 may be able to communicate with IoT devices 103 and gateways 107 that implement a variety of different communication technologies. As such, embodiments described herein facilitate configuration and reporting operations of IoT devices 103 in a manner that is agnostic as to (e.g., not dependent on) which communication technologies are implemented by IoT devices 103 and gateways 107, thus ultimately reducing the complexity of deploying, managing, and configuring IoT devices 103 and gateways 107.

In some embodiments, UICRP 101 may include APIs (e.g., external-facing APIs) to enable communication with other platforms or devices. For example, such APIs may be used to communicate with applications executing in data centers associated with cloud service providers, which may provide services such as data storage, compute scaling, authentication management, etc. In some embodiments, such APIs may also permit users of UICRP 101 to interact with UICRP 101 according to the examples provided herein (e.g., via a web-based user interface, via user equipment hosted applications, using language-model interfaces, programmatically, etc.).

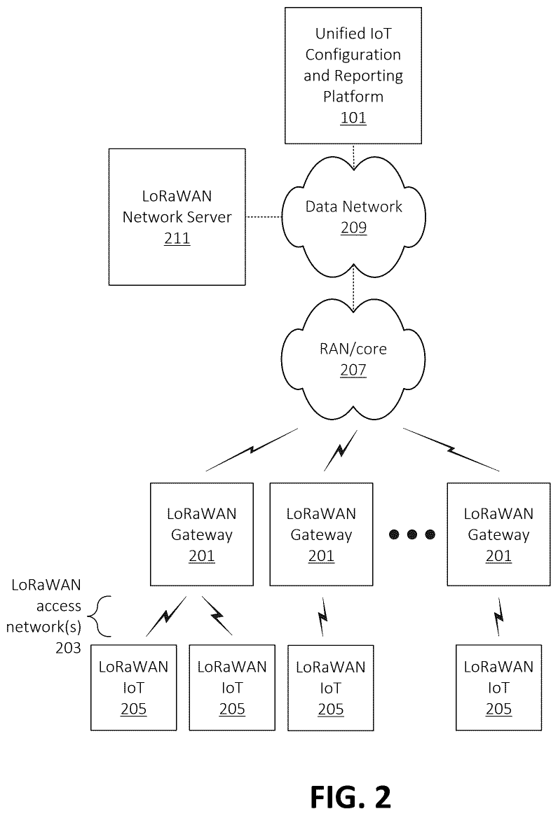

FIGS. 2-4 illustrate examples of different access networks 105 (e.g., which may be associated with different communication technologies) and corresponding gateways 107. For example, as discussed below, one or more gateways 107 may be or may include LoRaWAN gateways, BLE gateways, IO-Link gateways, and/or other types of gateways (e.g., that provide connectivity between respective IoT devices 103 and one or more other devices or networks). Additionally, as discussed below, one or more IoT devices 103 may be or may include LoRaWAN IoT devices, BLE IoT devices, IO-Link IoT devices, and/or other types of IoT devices (e.g., IoT devices that implement other types of communication technologies to communicate with respective gateways 107).

As shown in FIG. 2, for example, a set of LoRaWAN gateways 201 may implement one or more access networks 105 (e.g., one or more LoRaWAN access networks 203). LoRaWAN access networks 203 may operate according to a particular set of frequencies, bands, radio access technologies (“RATs”), etc. corresponding to one or more LoRaWAN standards. In some implementations, LoRaWAN access networks 203 may operate according to a sub-Gigahertz (“GHz”) band such as a 868 Megahertz (“MHz”) band, a 902-928 MHz band, a 915-928 MHz band, and/or some other suitable band. For example, LoRaWAN gateways 201 may include a first set of wireless hardware circuitry (e.g., antennas, transceivers, radios, or the like) that operates according to the particular set of frequencies, bands, RATs, etc. corresponding to one or more LoRaWAN standards.

A given LoRaWAN gateway 201 may communicate with one or more LoRaWAN IoT devices 205 via LoRaWAN access network 203. For example, LoRaWAN IoT devices 205 may operate according to the same particular set of frequencies, bands, RATs, etc. as implemented by LoRaWAN gateway 201 (e.g., corresponding to one or more particular LoRaWAN standards). In one embodiment, a particular LoRaWAN IoT device 205 may be considered as a particular IoT device 103 that further includes wireless hardware circuitry that operates according to the above-mentioned frequencies, bands, RATs, etc. For example, LoRaWAN gateway 201 may include a temperature sensor that monitors ambient air temperature, and outputs uplink information such as periodic and/or conditional reports and/or alerts via LoRaWAN access network 203 (e.g., via LoRaWAN gateway 201).

LoRaWAN gateway 201 may further include a second set of wireless hardware circuitry that operates according to another set of frequencies, bands, RATs, etc. For example, LoRaWAN gateway 201 may include wireless hardware circuitry that operates according to a Long-Term Evolution (“LTE”) RAT, a Fifth Generation (“5G”) RAT, and/or some other type of RAT (e.g., a licensed RAT that operates according to frequencies that have been licensed by a governmental or other authoritative entity). LoRaWAN gateway 201 may communicate with a wireless network (e.g., which may include, may implement, or may be implemented by a RAN and/or a core network (e.g., RAN/core network 207). RAN/core network 207 may include, for example, wireless network infrastructure equipment such as base stations (e.g., evolved Node Bs (“eNBs”), Next Generation Node Bs (“gNBs”), or the like) that operate according to an LTE RAT, a 5G RAT, etc. In this manner, RAN/core network 207 may provide broader or wider range coverage (e.g., nationwide coverage or international coverage) than is provided via LoRaWAN access network 203. Accordingly, LoRaWAN IoT devices 205 may not have the need for more complex or costly radios or other wireless hardware that would be needed to communicate with RAN/core network 207.

RAN/core network 207 may provide routing services, such as routing traffic between LoRaWAN gateways 201 and one or more other networks, such as Data Network (“DN”) 209. In one example, DN 209 may include or may be communicatively coupled to a Wide Area Network (“WAN”), such as the Internet. LoRaWAN gateways 201 may communicate (e.g., via RAN/core network 207 and/or DN 209) with LoRaWAN Network Server 211. LoRaWAN Network Server 211 may perform functions such as administrative or configuration functions with respect to one or more LoRaWAN gateways 201. As one example, LoRaWAN Network Server 211 may provide “wake up” or listening interval configuration information to one or more LoRaWAN gateways 201, which may specify a manner in which a given LoRaWAN gateway 201 implements LoRaWAN access network 203. For example, LoRaWAN gateway 201 may remain in a low power or sleep mode for a given duration (sometimes referred to as a “sleep interval”), and may enter a high power or wake mode for another duration (sometimes referred to as a “wake interval”). Scheduling sleep and wake intervals may serve as an avenue of power consumption reduction, both from the standpoint of LoRaWAN gateways 201 (e.g., which may potentially have finite power sources such as batteries) as well as LoRaWAN IoT devices 205 which may also have potentially finite power sources. Additionally, scheduling sleep and wake intervals may serve as an avenue of reducing noise or interference in a LoRaWAN band, as LoRaWAN bands may be unlicensed bands that are potentially subject to uncontrolled traffic.

As another example, LoRaWAN Network Server 211 may serve as an interface for an administrator or operator associated with a given LoRaWAN gateway 201 or set of LoRaWAN gateways 201. LoRaWAN Network Server 211 may assist with functions such as access control (e.g., allowing certain LoRaWAN IoT devices 205 to register with or connect to a given LoRaWAN access network 203 implemented by a given LoRaWAN gateway 201), Quality of Service (“QoS”) management, power consumption management, and/or other suitable functions. In this sense, multiple LoRaWAN gateways 201 associated with the same owner or operator may be deployed in diverse geographical regions (e.g., in multiple cities, states, provinces, etc.), and may be managed via LoRaWAN Network Server 211. In some embodiments, LoRaWAN Network Server 211 may provide traffic aggregation and/or routing services. For example, LoRaWAN Network Server 211 may receive uplink information from LoRaWAN IoT devices 205 via LoRaWAN gateways 201, RAN/core network 207, and DN 209, and may forward some or all of such traffic to UICRP 101 and/or some other suitable device or system (e.g., via DN 209). In accordance with some embodiments, LoRaWAN Network Server 211 may receive downlink information (e.g., configuration instructions, alert thresholds, reporting intervals, etc.) from UICRP 101 (e.g., via DN 209), which is directed to one or more particular LoRaWAN IoT devices 205. LoRaWAN Network Server 211 may route such traffic to its indicated LoRaWAN IoT device 205 (e.g., via an associated LoRaWAN gateway 201), and LoRaWAN gateway 201 may provide such information to LoRaWAN IoT device 205 in accordance with one or more LoRaWAN techniques. For example, LoRaWAN gateway 201 may schedule a transmission (e.g., a transmission burst) of the information to LoRaWAN IoT device 205 during a wake duration associated with LoRaWAN gateway 201 and/or LoRaWAN IoT device 205.

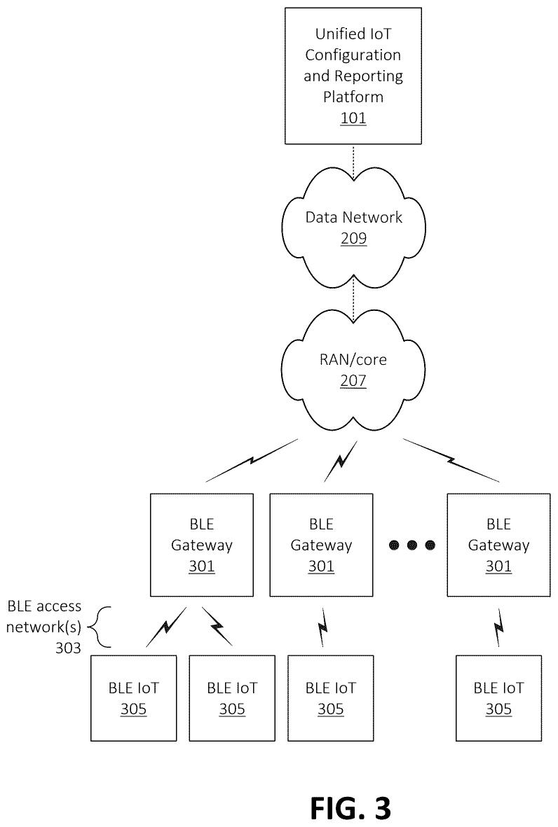

FIG. 3 illustrates another example deployment of particular IoT devices 103 and/or gateways 107. For example, a set of BLE gateways 301 may implement one or more access networks 105 (e.g., one or more BLE access networks 303). BLE access networks 303 may operate according to a particular set of frequencies, bands, RATs, etc. corresponding to one or more BLE standards. In some implementations, BLE access networks 303 may operate according to a 2.4 GHz band and/or some other suitable band. For example, BLE gateways 301 may include a first set of wireless hardware circuitry (e.g., antennas, transceivers, radios, or the like) that operates according to the particular set of frequencies, bands, RATs, etc. corresponding to one or more BLE standards.

A given BLE gateway 301 may communicate with one or more BLE IoT devices 305 via BLE access network 303. For example, BLE IoT devices 305 may operate according to the same particular set of frequencies, bands, RATs, etc. as implemented by BLE gateway 301 (e.g., corresponding to one or more particular BLE standards). In one embodiment, a particular BLE IoT device 305 may be considered as a particular IoT device 103 that further includes wireless hardware circuitry that operates according to the above-mentioned frequencies, bands, RATs, etc. For example, BLE gateway 301 may include a temperature sensor that monitors ambient air temperature, and outputs uplink information such as periodic and/or conditional reports and/or alerts via BLE access network 303 (e.g., via BLE gateway 301).

BLE gateway 301 may further include a second set of wireless hardware circuitry that operates according to another set of frequencies, bands, RATs, etc. For example, BLE gateway 301 may include wireless hardware circuitry that operates according to an LTE RAT, a 5G RAT, and/or some other type of RAT (e.g., a licensed RAT that operates according to frequencies that have been licensed by a governmental or other authoritative entity). BLE gateway 301 may communicate with a wireless network (e.g., which may include, may implement, or may be implemented by a RAN and/or a core network (e.g., RAN/core network 207). As discussed above, RAN/core network 207 may include wireless network infrastructure equipment such as base stations (e.g., eNBs, gNBs, or the like) that operate according to an LTE RAT, a 5G RAT, etc. In this manner, RAN/core network 207 may provide broader or wider range coverage (e.g., nationwide coverage or international coverage) than is provided via BLE access network 303. Accordingly, BLE IoT devices 305 may not have the need for more complex or costly radios or other wireless hardware that would be needed to communicate with RAN/core network 207. As discussed above, RAN/core network 207 may provide routing services, such as routing traffic between BLE gateways 301 and one or more other networks, such as DN 209. In one example, DN 209 may include or may be communicatively coupled to a WAN, such as the Internet.

BLE gateways 301 may be associated with configurable parameters such as power consumption parameters. The power consumption parameters may include “wake up” or listening interval configuration information, which may specify a manner in which a given BLE gateway 301 implements BLE access network 303. For example, BLE gateway 301 may remain in a low power or sleep mode for a given duration (sometimes referred to as a “sleep interval”), and may enter a high power or wake mode for another duration (sometimes referred to as a “wake interval”). Scheduling sleep and wake intervals may serve as an avenue of power consumption reduction, both from the standpoint of BLE gateways 301 (e.g., which may potentially have finite power sources such as batteries) as well as BLE IoT devices 305 which may also have potentially finite power sources. Additionally, scheduling sleep and wake intervals may serve as an avenue of reducing noise or interference in a BLE band, as BLE bands may be unlicensed bands that are potentially subject to uncontrolled traffic.

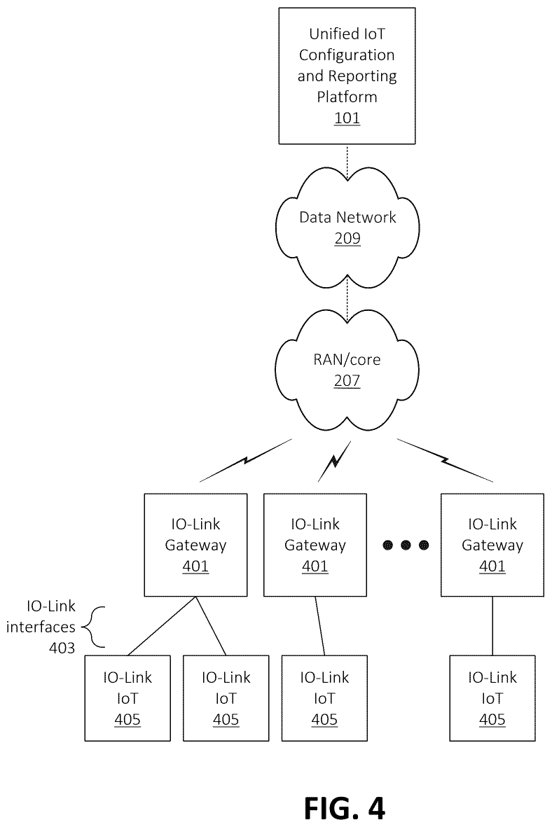

FIG. 4 illustrates another example deployment of particular IoT devices 103 and/or gateways 107. For example, a set of IO-Link gateways 401 may implement one or more IO-Link interfaces 403 (e.g., which may represent or may be represented by one or more access networks 105 in FIG. 1) . For example, IO-Link gateways 401 and/or IO-Link IoT devices 405 may include one or more ports or other types of interfaces (e.g., physical interfaces) which may be connected to each other via one or more wires, cables, etc. In some embodiments, such wires, cables, etc. may include M12 connectors or adapters, such as 4-pin M12 connectors, 8-pin M12 connectors, M12-to-RJ45 adapters, M12-to-USB adapters, etc.

In one embodiment, a particular IO-Link IoT device 405 may be considered as a particular IoT device 103 that further includes communication circuitry and/or other suitable hardware (e.g., ports, interfaces, jacks, etc.), such as wired communication circuitry and/or other suitable hardware. For example, IO-Link gateway 401 may include a temperature sensor that monitors ambient air temperature, and outputs uplink information such as periodic and/or conditional reports and/or alerts via UI-Link interface 403 (e.g., via IO-Link gateway 401).

IO-Link gateway 401 may further include a set of wireless hardware circuitry that operates according to another set of frequencies, bands, RATs, etc. For example, IO-Link gateway 401 may include wireless hardware circuitry that operates according to an LTE RAT, a 5G RAT, and/or some other type of RAT (e.g., a licensed RAT that operates according to frequencies that have been licensed by a governmental or other authoritative entity). IO-Link gateway 401 may communicate with a wireless network (e.g., which may include, may implement, or may be implemented by a RAN and/or a core network (e.g., RAN/core network 207). As discussed above, RAN/core network 207 may include wireless network infrastructure equipment such as base stations (e.g., eNBs, gNBs, or the like) that operate according to an LTE RAT, a 5G RAT, etc. In this manner, RAN/core network 207 may provide broader or wider range coverage (e.g., nationwide coverage or international coverage) than is provided via UI-Link interface 403. Accordingly, IO-Link IoT devices 405 may not have the need for more complex or costly radios or any type of wireless hardware that would be needed to communicate with RAN/core network 207. As discussed above, RAN/core network 207 may provide routing services, such as routing traffic between IO-Link gateways 401 and one or more other networks, such as DN 209. In one example, DN 209 may include or may be communicatively coupled to a WAN, such as the Internet.

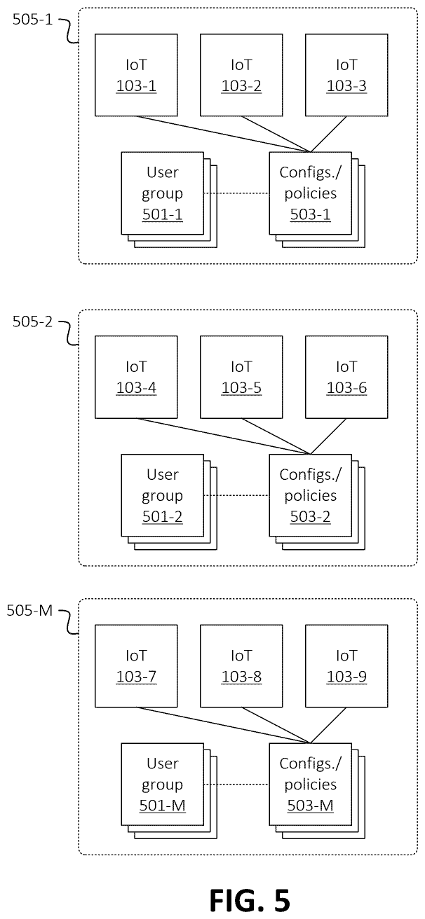

As discussed above, different IoT devices 103 may be associated with different owners, operators, or other such entities. For example, a particular organization may deploy, manage, etc. a particular set of IoT devices 103 for use by one or more user groups, such as employees, customers, vendors, partner entities, etc. As shown in FIG. 5, for example, a first set of IoT devices 103 (e.g., IoT devices 103-1, 103-2, and 103-3) may be associated with a first user group 501-1, a second set of IoT devices 103 (e.g., IoT devices 103-4, 103-5, and 103-6) may be associated with a second user group 501-2, a third set of IoT devices 103 (e.g., IoT devices 103-7, 103-8, and 103-9) may be associated with a third user group 501-M, and so on. Respective sets of IoT devices 103 with their associated user groups 501, along with configurations and/or policies associated with user groups 501 and/or corresponding IoT devices 103, may be represented as domains 505. For example, domain 505-1 may be associated with or may include user group 501-1 and their associated IoT devices 103 and configurations and/or policies 503-1, domain 505-2 may be associated with or may include user group 501-2 and their associated IoT devices 103 and configurations and/or policies 503-2, and domain 505-M may be associated with or may include user group 501-M and their associated IoT devices 103 and configurations and/or policies 503-M.

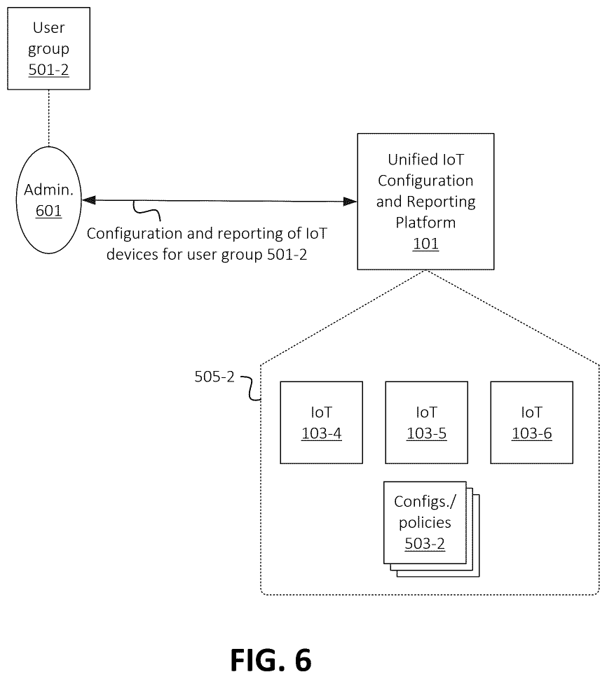

An administrator, operator, and/or other such entity associated with each respective user group 501 may, for example, register their respective IoT devices 103 with UICRP 101, which may include providing device identifiers, IP addresses, Media Access Control (“MAC”) addresses, serial numbers or other unique hardware device identifiers, Extended Unique Identifiers (“EUIs”), Device Unique Identifiers (“DevEUIs”), vendor identifiers, and/or other suitable communication or identification information associated with respective IoT devices 103 to UICRP 101. For example, as shown in FIG. 6, administrator 601, associated with user group 501-2 (e.g., domain 505-2) may configure, register, manage, etc. IoT devices 103 associated with domain 505-2 (e.g., IoT devices 103-4, 103-5, and 103-6). For example, administrator 601 may utilize an administrator console, a workstation, and/or other suitable type of device that is communicatively coupled to UICRP 101 (e.g., via one or more APIs, SDKs, or other suitable communication pathways). Administrator 601 may, for example, provide device identifiers, IP addresses, MAC addresses, or other suitable communication or identification information associated with IoT devices 103-4, 103-5, and 103-6. In some embodiments, administrator 601 may additionally provide communication information, authentication information, authorization information, identification information, and/or other suitable information associated with one or more users or devices associated with user group 501-2, such as user names, authentication tokens, certificates, or other such information.

Administrator 601 may also provide configurations and/or policies 503-2 to UICRP 101. In some embodiments, configurations and/or policies 503 (e.g., configurations and/or policies 503-2) may include access control policies (e.g., user and/or device identifiers (e.g., IP addresses, device identifiers, etc.) of users and/or devices that are authorized to receive uplink information from IoT devices 103 of domain 505-2 and/or that are authorized to provide downlink information to IoT devices 103 of domain 505-2. As another example, configurations and/or policies 503 may include alerting policies, monitoring policies, reporting policies, and/or one or more other policies for one or more IoT devices 103 of domain 505-2. For example, configurations and/or policies 503 may specify a particular reporting interval (e.g., output a sensor reading every 15 minutes) for IoT device 103-4, a particular alert threshold (e.g., output a sensor reading or alert when a particular monitored value crosses or reaches a threshold value), power consumption parameters (e.g., wake and/or sleep intervals), and/or other suitable configuration information.

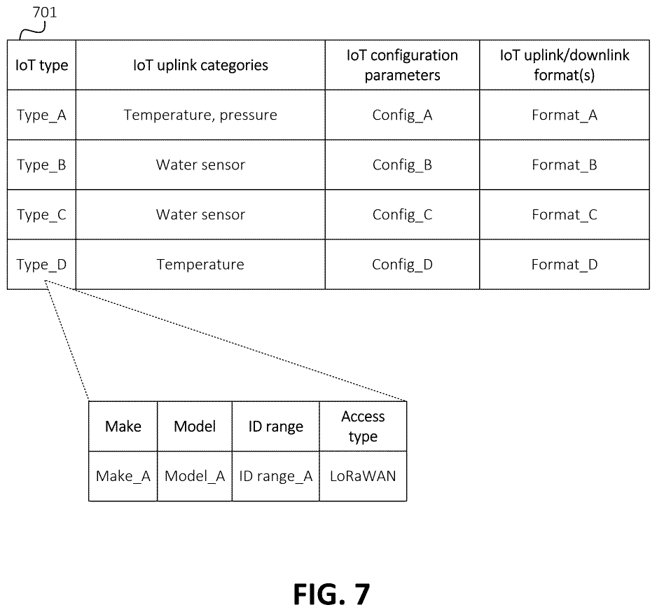

In order to provide a unified interface and point of access for users accessing IoT devices 103, UICRP 101 may maintain information associating each IoT device 103 with a set of parameters that can be used to aggregate and normalize disparate types and/or formats of uplink information from different types of IoT devices 103. FIG. 7 illustrates example data structure 701, which may be generated, maintained, and/or used by UICRP 101 to provide a unified interface and point of access for multiple IoT devices 103. In some embodiments, data structure 701 may be generated or refined using artificial intelligence/machine learning (“AI/ML”) techniques or other model-based and/or automated techniques.

As shown, data structure 701 includes information such as characteristics, attributes, etc. associated with different types of IoT devices 103. In this example, different IoT device types are represented with the labels “Type_A,” “Type_B,” “Type_C,” and “Type_D.” A different IoT device type, as referred to herein, may represent differentiating characteristics such as manufacturer (e.g., make) and/or model information, hardware capabilities such as types (e.g., temperature, motion, accelerometer, etc.) and/or quantities of sensors, version or revision information (e.g., version or revision of hardware or firmware), device identifier (e.g., MAC address or range of MAC addresses, serial number or range of serial numbers, EUI or range of EUIs, DevEUI or range of DevEUIs, etc.), access technology information (e.g., LoRaWAN, BLE, IO-Link, etc.), or other characteristics.

Data structure 701 may include, for each type of IoT device 103, IoT uplink and/or downlink formatting information (represented as “Format_A” for Type_A, “Format_B” for Type_B, and so on). IoT uplink formatting information may include mapping information, models, translation information, and/or other information which may be used to convert or extract uplink information received from a given IoT device 103 to a standard, unified format. Additionally, the IoT downlink formatting information may include mapping information, models, translation information, and/or other information which may be used to convert or extract downlink information, to send to a given IoT device 103, to a device-specific format which may be different from the standard, unified format. For example, the IoT uplink and/or downlink format information may be based on APIs or protocols used by particular types of IoT devices 103 (e.g., Message Queuing Telemetry Transport (“MQTT”) protocol or some other protocol), variables or data types used by particular types of IoT devices 103 (e.g., a decimal value representing a temperature, a binary value indicating operational status, a string value representing location information, and/or other variables or data types), or the like. In some embodiments, IoT uplink and/or downlink format information may include message formatting or syntactical information used by particular types of IoT devices 103, such as an indication of function calls and/or associated parameters that may be invoked by particular types of IoT devices 103, conditional logic or policies used by IoT devices 103 to determine whether to perform certain operations, comparators such as greater than or less than, delineation or tokenization information that specifies how to parse messages to or from particular types of IoT devices 103, or other such information.

In this manner, UICRP 101 may use IoT uplink and/or downlink formatting information to parse or “interpret” uplink messages from particular IoT devices 103 and/or downlink messages directed to particular IoT devices 103. The uplink and/or downlink formatting information and/or other information may be used to identify IoT uplink categories and/or IoT configuration parameters associated with a given type of IoT device 103. For example, based on a particular IoT uplink and/or downlink format (e.g., Format_A associated with a Type_A IoT device 103, UICRP 101 may identify that uplink information from this type of IoT device 103 includes temperature sensor information and pressure sensor information (e.g., that such IoT device 103 includes one or more temperature sensors and/or one or more pressure sensors).

In one example, a standard, unified format may be defined for a given type of sensor. For example, UICRP 101 may maintain or use a first format to represent uplink data associated with temperature sensors, a second format to represent uplink data associated with pressure sensors, a third format to represent uplink data associated with water sensors, and so on. For example, while different temperature sensors may utilize different uplink formats (e.g., different quantities of decimals in temperature readings, different temperature scales such as Fahrenheit or Celsius, different messaging protocols or message formats, etc.), the unified format may be normalized such that it is not necessary for a user device accessing the sensor information from multiple different temperature sensors to be able to parse, interpret, etc. different types of uplink message formats from different temperature sensors.

Similarly, data structure 701 may include IoT configuration parameters for each type of IoT device 103. For example, different types of IoT device 103 may have different parameters that can be configured, such as reporting interval, sensitivity, alert thresholds, or the like. As discussed above, instructions (e.g., downlink messages) to implement certain parameters by different types of IoT devices 103 may be associated with different protocols, APIs, syntax, or the like (e.g., different types of IoT devices 103 may interpret or parse messages or instructions differently). The IoT configuration parameters (e.g., Config_A for Type_A IoT devices 103) may include normalized or unified parameters, such that from a user perspective (e.g., a user accessing UICRP 101 to configuration Type_A IoT devices 103), each different IoT device 103 of Type_A is able to be configured in a similar manner, even if the actual instructions or messaging formats to different IoT devices 103 of the same type differ. In this manner, a user may be able to obtain a homogenous user experience both for uplink information (e.g., IoT monitoring and/or alert information) and downlink information (e.g., IoT configuration parameters), even for IoT devices 103 that utilize different uplink and/or downlink formatting parameters.

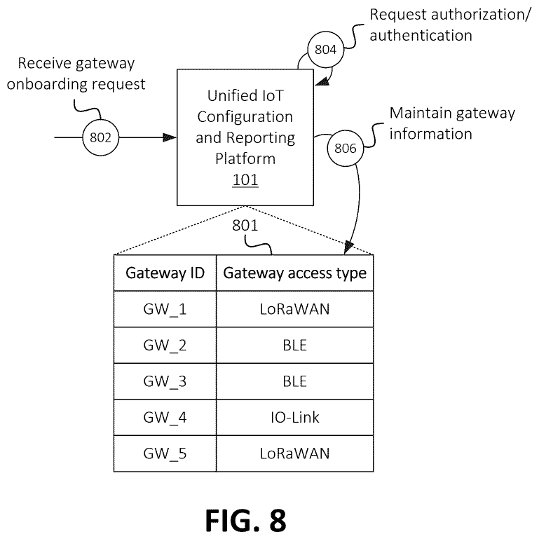

As shown in FIG. 8, UICRP 101 may also maintain information associated with different gateways 107. For example, different respective gateways 107 (e.g., LoRaWAN gateways 201, BLE gateways 301, and/or IO-Link Gateways 401) may be onboarded to or registered with UICRP 101 based on one or more onboarding requests (at 802). For example, an administrator, operator, etc. associated with one or more gateways 107 may provide an onboarding request via an API, a web portal, an application, and/or some other suitable communication pathway with UICRP 101. In one example embodiment, UICRP 101 may present a graphical user interface (“GUI”), a web portal, or the like, which may be accessed via a workstation, an administrator console, or some other type of device. As another example, UICRP 101 may be communicatively coupled to an IoT management system or a user-facing IoT platform (e.g., via an API), where the IoT management system or user-facing IoT platform serves as an interface between UICRP 101 and one or more user devices.

In some embodiments, the gateway onboarding request (at 802) may include identifying information associated with a particular IoT gateway 107, such as a serial number, a device identifier, a MAC identifier, or some other suitable identifier. In some embodiments, the gateway onboarding request may include network credentials and/or wireless hardware identifier information of IoT gateway 107, such as an International Mobile Station Equipment Identity (“IMEI”), an International Mobile Subscriber Identity (“IMSI”), a Subscription Permanent Identifier (“SUPI”), a Globally Unique Temporary Identifier (“GUTI”), or the like. In some embodiments, the onboarding request may specify a type of access technology used by IoT gateway 107 to communicate with IoT devices 103, such as LoRaWAN, BLE, IO-Link, etc.

In some embodiments, UICRP 101 may authenticate (at 804) and/or verify the request. For example, UICRP 101 may determine whether the request is from an authorized source. For example, the requestor (e.g., an administrator, owner, etc. onboarding a given gateway 107) may have previously registered with UICRP 101, which may include establishing authentication credentials, establishing authorization policies, etc., whereby such entity is able to be authenticated and verified by UICRP 101.

Assuming UICRP 101 authenticates and verifies authorization for the request, UICRP 101 may maintain (at 806) information regarding one or more registered IoT gateways 107. UICRP 101 may, for instance, maintain data structure 801 or some other suitable similar information that includes information regarding one or more gateways 107. For example, for each gateway identifier or range of identifiers (e.g., MAC addresses, ranges of MAC addresses, IMEI values, ranges of IMEI values, etc.), data structure 801 may include information indicating a gateway access type. In some embodiments, data structure 801 may include additional or different types of information, such as a location of IoT gateway 107 (e.g., latitude and longitude coordinates, a cell or coverage area of a wireless network, a Tracking Area (“TA”) of a wireless network, a physical address, and/or some other designation of a geographical location). As discussed below, UICRP 101 may utilize such information when selecting a particular onboarding procedure to onboard IoT devices 103 that are connected to respective IoT gateways 107.

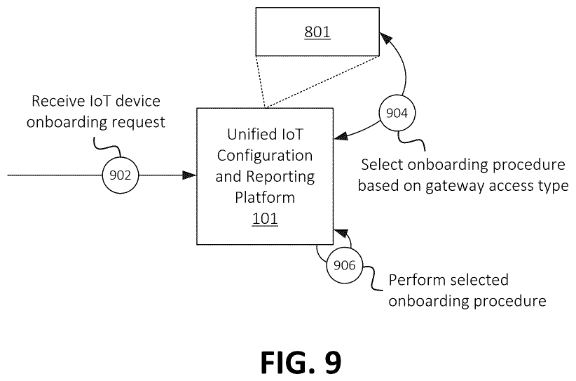

For example, as shown in FIG. 9, UICRP 101 may receive (at 902) an IoT device onboarding request. The request may take the form of a request from a user, operator, etc. associated with a given IoT device 103 to be onboarded. For example, the request may originate from a user that is deploying or installing IoT device 103 at a given location, such as a warehouse, a manufacturing facility, a residential home, an office, or some other type of location. In some embodiments, the request may be received via an API, a web portal, or the like. In some embodiments, as discussed above, an IoT management platform or some other suitable device or system may issue the request to UICRP 101. In some embodiments, the request (at 902) may take the form of uplink data from a given IoT device 103 (e.g., IoT device 103 may automatically output uplink data when connecting to a respective IoT gateway 107).

The IoT device onboarding request may include, in some embodiments, one or more identifiers of IoT device 103, such as device identifiers (e.g., serial numbers, hardware identifiers, MAC addresses, or the like). In this manner, UICRP 101 may be able to discern new IoT devices 103 (e.g., IoT devices 103 that have yet to be onboarded) from IoT devices 103 that have already been onboarded. In some embodiments, UICRP 101 may identify a particular gateway 107 associated with IoT device 103. For example, the IoT device onboarding request may include an identifier of a given IoT gateway 107 to which IoT device 103 is connected. As another example, the onboarding request (or uplink information) may be received from IoT device 103 itself after IoT device 103 has connected to IoT gateway 107, and the request itself may include information (e.g., header information, metadata, etc.) that includes an identifier of IoT gateway 107. UICRP 101 may, in some embodiments, identify a particular IoT gateway 107 with which IoT device 103 is associated (e.g., to which IoT device 103 has connected or may connect to in the future) in some other suitable manner.

UICRP 101 may select (at 904) a particular onboarding procedure based on a gateway access technology type. For example, UICRP 101 may identify, based on information stored in data structure 801, an access technology type of IoT gateway 107 with which the IoT onboarding request is associated. As discussed below, the onboarding procedure may include a first onboarding procedure (e.g., referred to below as a “manual” onboarding procedure), a second onboarding procedure (e.g., referred to below as a “semi-automatic” onboarding procedure), a third onboarding procedure (e.g., referred to below as an “automatic” onboarding procedure), or some other suitable onboarding procedure. UICRP 101 may accordingly perform (at 906) the selected onboarding procedure, in order to begin providing unified IoT configuration and reporting services for IoT device 103.

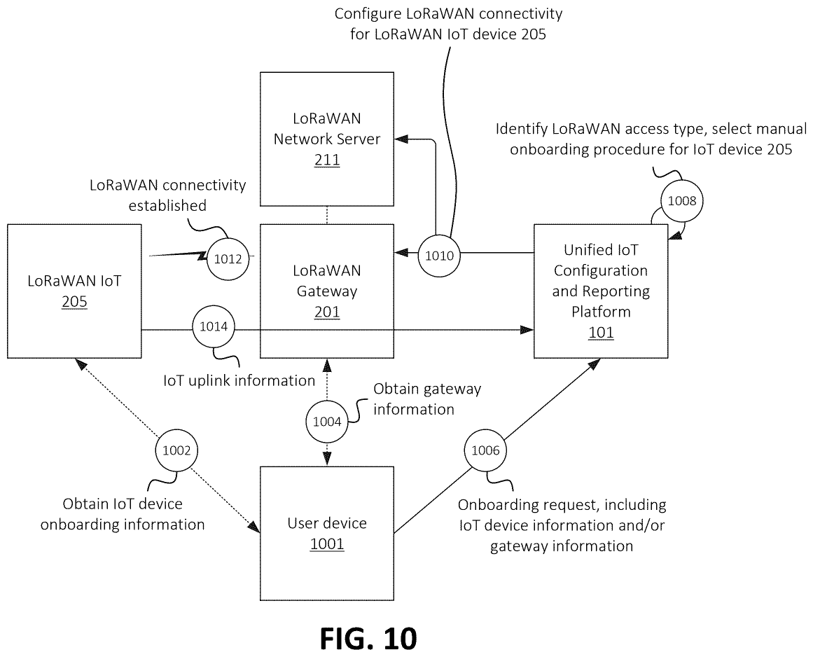

FIGS. 10-12 illustrate examples of performing (e.g., at 906) different respective onboarding procedures, in accordance with some embodiments. FIG. 10 illustrates, for example, a “manual” IoT device onboarding procedure for a given LoRaWAN IoT device 205. Although this procedure is referred to as a “manual” procedure, certain portions of this onboarding procedure may be performed automatically. In the manual onboarding procedure shown in FIG. 10, for example, a user or user device 1001 may obtain (at 1002) IoT device onboarding information, such as one or more device identifiers of LoRaWAN IoT device 205. For example, LoRaWAN IoT device 205 may include one or more stickers, labels, Quick Response (“QR”) codes, or other information which may be obtained or identified by a user of user device 1001, by a camera of user device 1001, or the like. The sticker, label, QR code, etc. may include or may specify a device identifier of LoRaWAN IoT device 205, such as a serial number, a device identifier, an EUI, a DevEUI, an Appkey, an application EUI (“AppEUI”), and/or some other suitable unique identifier.

In some embodiments, user device 1001 may also obtain (at 1004) gateway information, such as a device identifier, IP address, or other suitable identifier of LoRaWAN gateway 201. In some embodiments, such information may be physically visible on LoRaWAN gateway 201, such as on a housing or body of LoRaWAN gateway 201. Additionally, or alternatively, user device 1001 may obtain such information by communicating with LoRaWAN gateway 201 via one or more appropriate communication technologies.

In some embodiments, the onboarding procedure may forgo (e.g., not include) obtaining (at 1004) gateway information. For example, in some embodiments, user device 1001 may output (at 1006) an onboarding request to UICRP 101, which includes IoT device information (e.g., a device identifier of LoRaWAN IoT device 205, as discussed above), but does not include information regarding LoRaWAN gateway 201. On the other hand, in some embodiments, the onboarding request may include the IoT device information as well as LoRaWAN gateway information. In some embodiments, the onboarding request may specify that LoRaWAN IoT device 205 is associated with a LoRaWAN access type, and/or UICRP 101 may otherwise identify that LoRaWAN IoT device 205 is associated with a LoRaWAN access type.

In embodiments where the onboarding request includes the identifier of LoRaWAN gateway 201, UICRP 101 may identify that the onboarding request is specific to a new LoRaWAN IoT device 205 to be onboarded via LoRaWAN gateway 201. In embodiments where the onboarding request does not specifically include an identifier or other suitable information of a specific LoRaWAN gateway 201, UICRP 101 may identify one or more LoRaWAN gateways 201 (e.g., as potential candidates for the onboarding). For example, UICRP 101 may identify some or all LoRaWAN gateways 201 with which a user group 501 and/or domain 505 are associated. In some embodiments, the request may include location information (e.g., a location of LoRaWAN IoT device 205), and/or UICRP 101 may otherwise identify location information associated with LoRaWAN IoT device 205. In some embodiments, UICRP 101 may identify one or more LoRaWAN gateways 201 that are located in, or that serve, the location of LoRaWAN IoT device 205.

UICRP 101 may further identify (at 1008) that LoRaWAN IoT device 205 is associated with a manual onboarding procedure. For example, UICRP 101 may identify that the manual onboarding procedure has been initiated on the basis of receiving (at 1006) a request to onboard LoRaWAN IoT device 205. Additionally, or alternatively, UICRP 101 may identify that the manual onboarding procedure should be selected on the basis of determining that LoRaWAN IoT device 205 is associated with an LoRaWAN access type.

As part of the manual onboarding procedure, UICRP 101 may communicate (at 1010) with LoRaWAN gateway 201 and/or LoRaWAN Network Server 211 to configure LoRaWAN connectivity for LoRaWAN IoT device 205. In one example embodiment, UICRP 101 may provide a device identifier of LoRaWAN IoT device 205 to LoRaWAN gateway 201 and/or to LoRaWAN Network Server 211. In situations where UICRP 101 identifies multiple potential candidate LoRaWAN gateways 201 (e.g., multiple LoRaWAN gateways 201 associated with a given location, user group 501, and/or domain 505), UICRP 101 may output the device identifier of LoRaWAN IoT device 205 to all of such LoRaWAN gateways 201, and/or may indicate that LoRaWAN Network Server 211 should output the device identifier of LoRaWAN IoT device 205 to LoRaWAN gateways 201 associated with a given location, user group 501, and/or domain 505. In this manner, one or more LoRaWAN gateways 201 may be configured to communicate with (e.g., discover) LoRaWAN IoT device 205 based on the provided device identifier.

For example, LoRaWAN IoT device 205 may broadcast or otherwise wirelessly output its device identifier, and LoRaWAN gateway 201 may “listen” for such device identifier. In this sense, LoRaWAN IoT device 205 may be added to a “whitelist” associated with LoRaWAN gateway 201, where LoRaWAN gateway 201 is configured to communicate with IoT devices that are on the whitelist, and is not configured to communicate with IoT devices that are not on the whitelist. In one example embodiment, UICRP 101 and/or LoRaWAN Network Server 211 may instruct LoRaWAN gateway 201 to “wake” (e.g., exit a low power mode, exit a sleep mode, etc.) in order to establish (at 1012) connectivity with LoRaWAN IoT device 205. Once connected, LoRaWAN IoT device 205 may proceed to output (at 1014) IoT uplink information to UICRP 101, via LoRaWAN gateway 201. Such instruction may be outside of a scheduled wake interval for LoRaWAN gateway 201. In this manner, LoRaWAN IoT device 205 may be connected to LoRaWAN gateway 201 more quickly than implementations in which LoRaWAN gateway 201 attempts to connect with LoRaWAN IoT device 205 during its next wake interval.

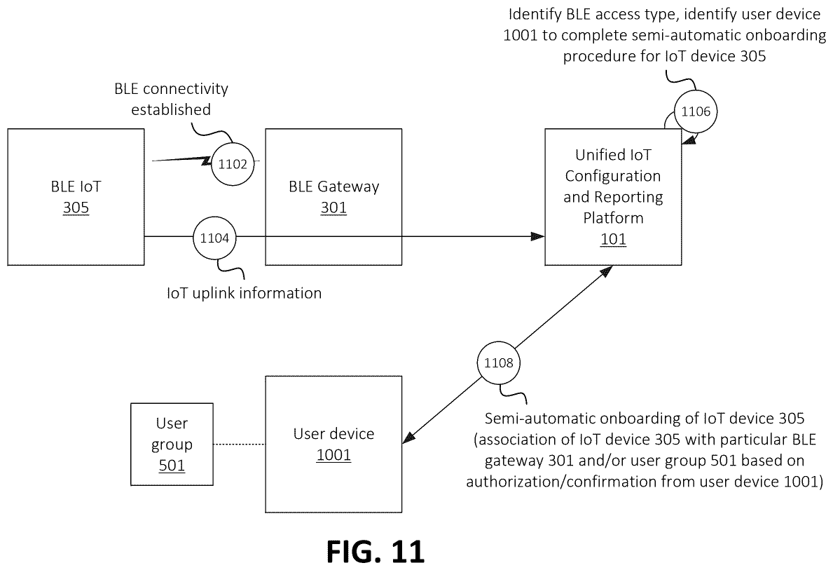

FIG. 11 illustrates an example semi-automatic IoT device onboarding operation, in accordance with some embodiments. In some embodiments, the semi-automatic IoT device onboarding operation may be performed for BLE IoT devices 305 that have not yet been onboarded to UICRP 101. As shown, for example, a particular BLE IoT device 305 may connect (at 1102) to BLE gateway 301. For example, BLE gateway 301 and/or BLE IoT device 305 may have performed a BLE pairing operation, in which BLE gateway 301 and BLE IoT device 305 establish BLE connectivity with each other. BLE IoT device 305 may proceed to start sending (at 1104) IoT uplink information, such as sensor readings, operational status information, or other suitable information. In some embodiments, for example, BLE IoT device 305 may be configured to communicate with UICRP 101 via an API, SDK, etc. implemented by BLE IoT device 305. Additionally, or alternatively, BLE IoT device 305 may be configured to communicate with an intermediary system, such as an IoT management platform, that is communicatively coupled to UICRP 101 via an API, SDK, etc. For example, BLE IoT device 305 may output (at 1104) IoT uplink information with an IP address, hostname, Uniform Resource Locator (“URL”), device identifier, or other suitable identifier of UICRP 101 or the intermediary system.

UICRP 101 may receive the IoT uplink information originating from BLE IoT device 305, and may identify that BLE IoT device 305 has not yet been onboarded. For example, the uplink information may include a device identifier of BLE IoT device 305, based on which UICRP 101 may identify that BLE IoT device 305 has not previously been onboarded to UICRP 101. In some embodiments, UICRP 101 may identify that the IoT uplink information was received via BLE gateway 301, such as based on header information or other suitable information in the IoT uplink information (e.g., as added by BLE gateway 301). UICRP 101 may accordingly determine (at 1106, e.g., based on determining that BLE IoT device 305 has not previously been onboarded, and further based on determining that BLE IoT device 305 is communicating with BLE gateway 301 using a BLE communication technology) that a semi-automatic onboarding procedure should be initiated for BLE IoT device 305.

As part of the semi-automatic IoT device onboarding procedure, UICRP 101 may communicate (at 1108) with one or more user devices 1001 in order to associate BLE IoT device 305 with a particular user group 501 or domain 505. For example, UICRP 101 may “push” a notification to one or more user devices 1001 that are associated with a user group 501 or domain 505 with which BLE gateway 301 has been previously registered, indicating that BLE IoT device 305 is available for onboarding. Additionally, or alternatively, UICRP 101 may “push” a notification to one or more user devices 1001 that are located within a threshold geographical location of BLE gateway 301, indicating that BLE IoT device 305 is available for onboarding. In some embodiments, UICRP 101 may present a GUI or other suitable type of information indicating one or more BLE IoT devices 305 from which IoT uplink information has been received, but which have not been onboarded (e.g., which have not yet been associated with a particular user group 501 or domain 505). In one example, such GUI may include a partially masked device identifier of BLE IoT device 305 or other masked information, where an individual that is authorized to access or onboard BLE IoT device 305 may be able to provide the remainder of the information. For example, assuming a device identifier of BLE IoT device 305 is “ABCD1234,” the GUI may present information such as “device XXXX1234 is available for onboarding,” and a user may select such device for associating with a particular user group 501 or domain 505 by providing the missing information (e.g., “ABCD” for “XXXX”). In this sense, a given user or user device 1001 may securely “claim” a particular BLE IoT device 305 that has started to provide IoT uplink information to UICRP 101.

Once BLE IoT device 305 has been onboarded (e.g., associated with a particular user group 501 or domain 505), BLE IoT device 305 may be able to receive configuration and/or reporting services associated with UICRP 101. For example, as discussed above, authorized users may begin to configure BLE IoT device 305 and/or receive IoT uplink information from BLE IoT device 305, via UICRP 101.

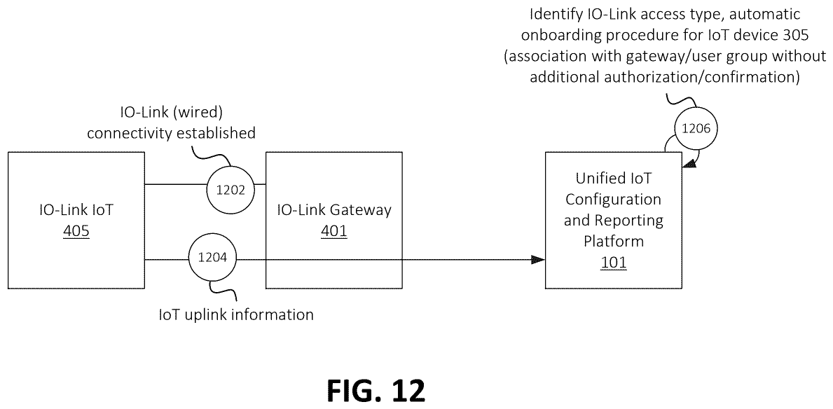

FIG. 12 illustrates an example automatic onboarding operation, in accordance with some embodiments. In some embodiments, the automatic IoT device onboarding operation may be performed for IO-Link IoT devices 405 that have not yet been onboarded to UICRP 101. As shown, for example, a particular IO-Link IoT device 405 may connect (at 1202) to IO-Link Gateway 401. For example, as discussed above, IO-Link Gateway 401 may include one or more physical ports, interfaces, etc., to which IO-Link IoT device 405 may connect (e.g., via a cable, wire, connector, adapter, etc.).

IO-Link IoT device 405 may proceed to start sending (at 1204) IoT uplink information, such as sensor readings, operational status information, or other suitable information, via the wired connection with IO-Link Gateway 401. In some embodiments, for example, IO-Link IoT device 405 may be configured to communicate with UICRP 101 via an API, SDK, etc. implemented by IO-Link IoT device 405. Additionally, or alternatively, IO-Link IoT device 405 may be configured to communicate with an intermediary system, such as an IoT management platform, that is communicatively coupled to UICRP 101 via an API, SDK, etc. For example, IO-Link IoT device 405 may output (at 1204) IoT uplink information with an IP address, hostname, URL, device identifier, or other suitable identifier of UICRP 101 or the intermediary system.

In accordance with some embodiments, by virtue of being connected to IO-Link Gateway 401 via a wired link, UICRP 101 may determine (at 1206) that an automatic onboarding operation should be performed with respect to IO-Link IoT device 405. For example, in some embodiments, UICRP 101 may associate IO-Link IoT device 405 with a particular user group 501 and/or domain 505 with which IO-Link Gateway 401, from which the IoT uplink information was received. In this manner, IO-Link IoT devices 405 may be able to be deployed and quickly spun up without additional configuration. Security of the system, even with the automatic onboarding operation, may be maintained by the requirement to physically connect IO-Link IoT devices 405 to IO-Link Gateways 401.

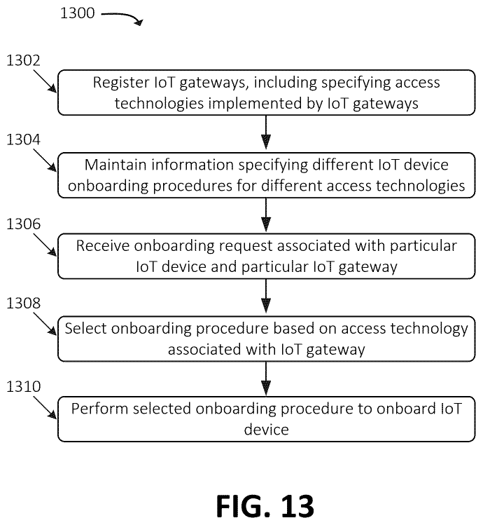

FIG. 13 illustrates an example process 1300 for selectively performing different IoT onboarding processes for IoT devices that communicate using different access technologies. In some embodiments, some or all of process 1300 may be performed by UICRP 101.

As shown, process 1300 may include registering (at 1302) a set of IoT gateways 107. As discussed above, registering a particular IoT gateway 107 may include specifying, determining, identifying, etc. an IoT access technology implemented by the particular IoT gateway 107 (e.g., an access technology via which IoT gateway 107 provides connectivity to one or more IoT devices 103). Such access technologies may include, for example, a LoRaWAN access technology, a BLE access technology, an IO-link access technology, or some other suitable wired or wireless access technology.

Process 1300 may further include maintaining (at 1304) information specifying different IoT device onboarding procedures for different access technologies. In examples described above, these different IoT device onboarding procedures may include a manual IoT device onboarding procedure (e.g., as discussed above with respect to FIG. 10, for LoRaWAN gateways 201 and LoRaWAN IoT devices 205), a semi-automatic IoT device onboarding procedure (e.g., as discussed above with respect to FIG. 11, for BLE gateways 301 and BLE IoT devices 305), and/or an automatic IoT device onboarding procedure (e.g., as discussed above with respect to FIG. 12, for IO-Link Gateways 401 and IO-Link IoT devices 405).

Process 1300 may additionally include receiving (at 1306) an onboarding request associated with a particular IoT device 103 and a particular IoT gateway 107. For example, as discussed above, UICRP 101 may receive such request directly from IoT device 103 (e.g., via IoT gateway 107), and/or some other suitable device or system (e.g., user device 1001). As discussed above, the request may include information identifying the type of access technology implemented by IoT device 103 and/or IoT gateway 107, an identifier of IoT gateway 107, and/or other suitable information based on which UICRP 101 may identify the access technology implemented by IoT device 103 and/or IoT gateway 107.

Process 1300 may also include selecting (at 1308) a particular IoT device onboarding procedure based on the access technology implemented by IoT device 103 and/or IoT gateway 107, and performing (at 1310) the selected IoT device onboarding procedure. For example, as discussed above, UICRP 101 may select a manual IoT device onboarding procedure for LoRaWAN gateways 201 and LoRaWAN IoT devices 205 (e.g., as discussed above with respect to FIG. 11), a semi-automatic IoT device onboarding procedure for BLE gateways 301 and BLE IoT devices 305 (e.g., as discussed above with respect to FIG. 12), and/or an automatic IoT device onboarding procedure for IO-Link Gateways 401 and IO-Link IoT devices 405 (e.g., as discussed above with respect to FIG. 13).

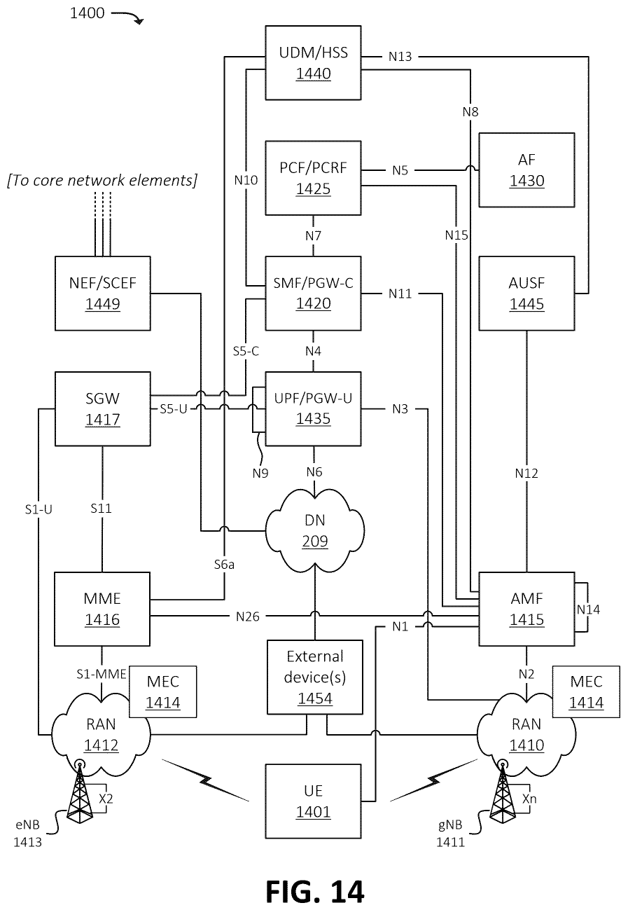

FIG. 14 illustrates an example environment 1400, in which one or more embodiments may be implemented. In some embodiments, environment 1400 may correspond to a 5G network, and/or may include elements of a 5G network. In some embodiments, environment 1400 may correspond to a 5G Non-Standalone (“NSA”) architecture, in which a 5G RAT may be used in conjunction with one or more other RATs (e.g., an LTE RAT), and/or in which elements of a 5G core network may be implemented by, may be communicatively coupled with, and/or may include elements of another type of core network (e.g., an evolved packet core (“EPC”)). In some embodiments, portions of environment 1400 may represent or may include a 5G core (“5GC”). As shown, environment 1400 may include UE 1401, RAN 1410 (which may include one or more Next Generation Node Bs (“gNBs”) 1411), RAN 1412 (which may include one or more evolved Node Bs (“eNBs”) 1413), and various network functions such as Access and Mobility Management Function (“AMF”) 1415, Mobility Management Entity (“MME”) 1416, Serving Gateway (“SGW”) 1417, Session Management Function (“SMF”)/Packet Data Network (“PDN”) Gateway (“PGW”)-Control plane function (“PGW-C”) 1420, Policy Control Function (“PCF”)/Policy Charging and Rules Function (“PCRF”) 1425, Application Function (“AF”) 1430, User Plane Function (“UPF”)/PGW-User plane function (“PGW-U”) 1435, Unified Data Management (“UDM”)/Home Subscriber Server (“HSS”) 1440, Authentication Server Function (“AUSF”) 1445, and Network Exposure Function (“NEF”)/Service Capability Exposure Function (“SCEF”) 1449. Environment 1400 may also include one or more networks, such as Data Network (“DN”) 209. Environment 1400 may include one or more additional devices or systems communicatively coupled to one or more networks (e.g., DN 209), such as one or more external devices 1454.

The example shown in FIG. 14 illustrates one instance of each network component or function (e.g., one instance of SMF/PGW-C 1420, PCF/PCRF 1425, UPF/PGW-U 1435, UDM/HSS 1440, and/or AUSF 1445). In practice, environment 1400 may include multiple instances of such components or functions. For example, in some embodiments, environment 1400 may include multiple “slices” of a core network, where each slice includes a discrete and/or logical set of network functions (e.g., one slice may include a first instance of AMF 1415, SMF/PGW-C 1420, PCF/PCRF 1425, and/or UPF/PGW-U 1435, while another slice may include a second instance of AMF 1415, SMF/PGW-C 1420, PCF/PCRF 1425, and/or UPF/PGW-U 1435). The different slices may provide differentiated levels of service, such as service in accordance with different Quality of Service (“QoS”) parameters.

The quantity of devices and/or networks, illustrated in FIG. 14, is provided for explanatory purposes only. In practice, environment 1400 may include additional devices and/or networks, fewer devices and/or networks, different devices and/or networks, or differently arranged devices and/or networks than illustrated in FIG. 14. For example, while not shown, environment 1400 may include devices that facilitate or enable communication between various components shown in environment 1400, such as routers, modems, gateways, switches, hubs, etc. In some implementations, one or more devices of environment 1400 may be physically integrated in, and/or may be physically attached to, one or more other devices of environment 1400. Alternatively, or additionally, one or more of the devices of environment 1400 may perform one or more network functions described as being performed by another one or more of the devices of environment 1400.

Additionally, one or more elements of environment 1400 may be implemented in a virtualized and/or containerized manner. For example, one or more of the elements of environment 1400 may be implemented by one or more Virtualized Network Functions (“VNFs”), Cloud-Native Network Functions (“CNFs”), etc. In such embodiments, environment 1400 may include, may implement, and/or may be communicatively coupled to an orchestration platform that provisions hardware resources, installs containers or applications, performs load balancing, and/or otherwise manages the deployment of such elements of environment 1400. In some embodiments, such orchestration and/or management of such elements of environment 1400 may be performed by, or in conjunction with, the open-source Kubernetes® application programming interface (“API”) or some other suitable virtualization, containerization, and/or orchestration system.

Elements of environment 1400 may interconnect with each other and/or other devices via wired connections, wireless connections, or a combination of wired and wireless connections. Examples of interfaces or communication pathways between the elements of environment 1400, as shown in FIG. 14, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 14, such as Service-Based Interfaces (“SBIs”), including an Namf interface, an Nudm interface, an Npcf interface, an Nupf interface, an Nnef interface, an Nsmf interface, and/or one or more other SBIs.

UE 1401 may include a computation and communication device, such as a wireless mobile communication device that is capable of communicating with RAN 1410, RAN 1412, and/or DN 209. UE 1401 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a programmable logic controller or other industrial controller, a Machine-to-Machine (“M2M”) device, or the like), a Fixed Wireless Access (“FWA”) device, or another type of mobile computation and communication device. UE 1401 may send traffic to and/or receive traffic (e.g., user plane traffic) from DN 209 via RAN 1410, RAN 1412, and/or UPF/PGW-U 1435. In some embodiments, UE 1401 may be, may include, may be implemented by, and/or may be communicatively coupled to user device 1001. In some embodiments, UE 1401 may be, may include, may be implemented by, and/or may be communicatively coupled to one or more IoT gateways 107.

RAN 1410 may be, or may include, a 5G RAN that implements a 5G RAT and that includes one or more base stations (e.g., one or more gNBs 1411), via which UE 1401 may communicate with one or more other elements of environment 1400. UE 1401 may communicate with RAN 1410 via an air interface (e.g., as provided by gNB 1411). For instance, RAN 1410 may receive traffic (e.g., user plane traffic such as voice call traffic, data traffic, messaging traffic, etc.) from UE 1401 via the air interface, and may communicate the traffic to UPF/PGW-U 1435 and/or one or more other devices or networks. Further, RAN 1410 may receive signaling traffic, control plane traffic, etc. from UE 1401 via the air interface, and may communicate such signaling traffic, control plane traffic, etc. to AMF 1415 and/or one or more other devices or networks. Additionally, RAN 1410 may receive traffic intended for UE 1401 (e.g., from UPF/PGW-U 1435, AMF 1415, and/or one or more other devices or networks) and may communicate the traffic to UE 1401 via the air interface.

RAN 1412 may be, or may include, an LTE RAN that implements an LTE RAT and that includes one or more base stations (e.g., one or more eNBs 1413), via which UE 1401 may communicate with one or more other elements of environment 1400. UE 1401 may communicate with RAN 1412 via an air interface (e.g., as provided by eNB 1413). For instance, RAN 1412 may receive traffic (e.g., user plane traffic such as voice call traffic, data traffic, messaging traffic, signaling traffic, etc.) from UE 1401 via the air interface, and may communicate the traffic to UPF/PGW-U 1435 (e.g., via SGW 1417) and/or one or more other devices or networks. Further, RAN 1412 may receive signaling traffic, control plane traffic, etc. from UE 1401 via the air interface, and may communicate such signaling traffic, control plane traffic, etc. to MME 1416 and/or one or more other devices or networks. Additionally, RAN 1412 may receive traffic intended for UE 1401 (e.g., from UPF/PGW-U 1435, MME 1416, SGW 1417, and/or one or more other devices or networks) and may communicate the traffic to UE 1401 via the air interface.

One or more RANs of environment 1400 (e.g., RAN 1410 and/or RAN 1412) may include, may implement, and/or may otherwise be communicatively coupled to one or more edge computing devices, such as one or more Multi-Access/Mobile Edge Computing (“MEC”) devices (referred to sometimes herein simply as a “MECs”) 1414. MECs 1414 may be co-located with wireless network infrastructure equipment of RANs 1410 and/or 1412 (e.g., one or more gNBs 1411 and/or one or more eNBs 1413, respectively). Additionally, or alternatively, MECs 1414 may otherwise be associated with geographical regions (e.g., coverage areas) of wireless network infrastructure equipment of RANs 1410 and/or 1412. In some embodiments, one or more MECs 1414 may be implemented by the same set of hardware resources, the same set of devices, etc. that implement wireless network infrastructure equipment of RANs 1410 and/or 1412. In some embodiments, one or more MECs 1414 may be implemented by different hardware resources, a different set of devices, etc. from hardware resources or devices that implement wireless network infrastructure equipment of RANs 1410 and/or 1412. In some embodiments, MECs 1414 may be communicatively coupled to wireless network infrastructure equipment of RANs 1410 and/or 1412 (e.g., via a high-speed and/or low-latency link such as a physical wired interface, a high-speed and/or low-latency wireless interface, or some other suitable communication pathway).

MECs 1414 may include hardware resources (e.g., configurable or provisionable hardware resources) that may be configured to provide services and/or otherwise process traffic to and/or from UE 1401, via RAN 1410 and/or 1412. For example, RAN 1410 and/or 1412 may route some traffic from UE 1401 (e.g., traffic associated with one or more particular services, applications, application types, etc.) to a respective MEC 1414 instead of to core network elements of 1400 (e.g., UPF/PGW-U 1435). MEC 1414 may accordingly provide services to UE 1401 by processing such traffic, performing one or more computations based on the received traffic, and providing traffic to UE 1401 via RAN 1410 and/or 1412. MEC 1414 may include, and/or may implement, some or all of the functionality described above with respect to UPF/PGW-U 1435, AF 1430, one or more application servers, and/or one or more other devices, systems, VNFs, CNFs, etc. In this manner, ultra-low latency services may be provided to UE 1401, as traffic does not need to traverse links (e.g., backhaul links) between RAN 1410 and/or 1412 and the core network.

AMF 1415 may include one or more devices, systems, VNFs, CNFs, etc., that perform operations to register UE 1401 with the 5G network, to establish bearer channels associated with a session with UE 1401, to hand off UE 1401 from the 5G network to another network, to hand off UE 1401 from the other network to the 5G network, manage mobility of UE 1401 between RANs 1410 and/or gNBs 1411, and/or to perform other operations. In some embodiments, the 5G network may include multiple AMFs 1415, which communicate with each other via the N14 interface (denoted in FIG. 14 by the line marked “N14” originating and terminating at AMF 1415).

MME 1416 may include one or more devices, systems, VNFs, CNFs, etc., that perform operations to register UE 1401 with the EPC, to establish bearer channels associated with a session with UE 1401, to hand off UE 1401 from the EPC to another network, to hand off UE 1401 from another network to the EPC, manage mobility of UE 1401 between RANs 1412 and/or eNBs 1413, and/or to perform other operations.

SGW 1417 may include one or more devices, systems, VNFs, CNFs, etc., that aggregate traffic received from one or more eNBs 1413 and send the aggregated traffic to an external network or device via UPF/PGW-U 1435. Additionally, SGW 1417 may aggregate traffic received from one or more UPF/PGW-Us 1435 and may send the aggregated traffic to one or more eNBs 1413. SGW 1417 may operate as an anchor for the user plane during inter-eNB handovers and as an anchor for mobility between different telecommunication networks or RANs (e.g., RANs 1410 and 1412).

SMF/PGW-C 1420 may include one or more devices, systems, VNFs, CNFs, etc., that gather, process, store, and/or provide information in a manner described herein. SMF/PGW-C 1420 may, for example, facilitate the establishment of communication sessions on behalf of UE 1401. In some embodiments, the establishment of communications sessions may be performed in accordance with one or more policies provided by PCF/PCRF 1425.

PCF/PCRF 1425 may include one or more devices, systems, VNFs, CNFs, etc., that aggregate information to and from the 5G network and/or other sources. PCF/PCRF 1425 may receive information regarding policies and/or subscriptions from one or more sources, such as subscriber databases and/or from one or more users (such as, for example, an administrator associated with PCF/PCRF 1425).

AF 1430 may include one or more devices, systems, VNFs, CNFs, etc., that receive, store, and/or provide information that may be used in determining parameters (e.g., quality of service parameters, charging parameters, or the like) for certain applications.

UPF/PGW-U 1435 may include one or more devices, systems, VNFs, CNFs, etc., that receive, store, and/or provide data (e.g., user plane data). For example, UPF/PGW-U 1435 may receive user plane data (e.g., voice call traffic, data traffic, etc.), destined for UE 1401, from DN 209, and may forward the user plane data toward UE 1401 (e.g., via RAN 1410, SMF/PGW-C 1420, and/or one or more other devices). In some embodiments, multiple instances of UPF/PGW-U 1435 may be deployed (e.g., in different geographical locations), and the delivery of content to UE 1401 may be coordinated via the N9 interface (e.g., as denoted in FIG. 14 by the line marked “N9” originating and terminating at UPF/PGW-U 1435). Similarly, UPF/PGW-U 1435 may receive traffic from UE 1401 (e.g., via RAN 1410, RAN 1412, SMF/PGW-C 1420, and/or one or more other devices), and may forward the traffic toward DN 209. In some embodiments, UPF/PGW-U 1435 may communicate (e.g., via the N4 interface) with SMF/PGW-C 1420, regarding user plane data processed by UPF/PGW-U 1435.

UDM/HSS 1440 and AUSF 1445 may include one or more devices, systems, VNFs, CNFs, etc., that manage, update, and/or store, in one or more memory devices associated with AUSF 1445 and/or UDM/HSS 1440, profile information associated with a subscriber. In some embodiments, UDM/HSS 1440 may include, may implement, may be communicatively coupled to, and/or may otherwise be associated with some other type of repository or database, such as a Unified Data Repository (“UDR”). AUSF 1445 and/or UDM/HSS 1440 may perform authentication, authorization, and/or accounting operations associated with one or more UEs 1401 and/or one or more communication sessions associated with one or more UEs 1401.

DN 209 may include one or more wired and/or wireless networks. For example, DN 209 may include an Internet Protocol (“IP”)-based PDN, a wide area network (“WAN”) such as the Internet, a private enterprise network, and/or one or more other networks. UE 1401 may communicate, through DN 209, with data servers, other UEs 1401, and/or to other servers or applications that are coupled to DN 209. DN 209 may be connected to one or more other networks, such as a public switched telephone network (“PSTN”), a public land mobile network (“PLMN”), and/or another network. DN 209 may be connected to one or more devices, such as content providers, applications, web servers, and/or other devices, with which UE 1401 may communicate.

External devices 1454 may include one or more devices or systems that communicate with UE 1401 via DN 209 and one or more elements of 1400 (e.g., via UPF/PGW-U 1435). In some embodiments, external devices 1454 may include, may implement, and/or may otherwise be associated with UICRP 101, LoRaWAN Network Server 211, and/or some other external device or system. External devices 1454 may include, for example, one or more application servers, content provider systems, web servers, or the like. External devices 1454 may, for example, implement “server-side” applications that communicate with “client-side” applications executed by UE 1401. External devices 1454 may provide services to UE 1401 such as gaming services, videoconferencing services, messaging services, email services, web services, and/or other types of services. Operations described above with respect to a given external device 1454 (e.g., in accordance with some embodiments) may be performed by a single device, by a cloud computing system, by one or more devices that implement a virtualized or containerized environment, a collection of devices, etc.

In some embodiments, external devices 1454 may communicate with one or more elements of environment 1400 (e.g., core network elements) via NEF/SCEF 1449. NEF/SCEF 1449 include one or more devices, systems, VNFs, CNFs, etc. that provide access to information, APIs, and/or other operations or mechanisms of one or more core network elements to devices or systems that are external to the core network (e.g., to external device 1454 via DN 209). NEF/SCEF 1449 may maintain authorization and/or authentication information associated with such external devices or systems, such that NEF/SCEF 1449 is able to provide information, that is authorized to be provided, to the external devices or systems. For example, a given external device 1454 may request particular information associated with one or more core network elements. NEF/SCEF 1449 may authenticate the request and/or otherwise verify that external device 1454 is authorized to receive the information, and may request, obtain, or otherwise receive the information from the one or more core network elements. In some embodiments, NEF/SCEF 1449 may include, may implement, may be implemented by, may be communicatively coupled to, and/or may otherwise be associated with a Security Edge Protection Proxy (“SEPP”), which may perform some or all of the functions discussed above. External device 1454 may, in some situations, subscribe to particular types of requested information provided by the one or more core network elements, and the one or more core network elements may provide (e.g., “push”) the requested information to NEF/SCEF 1449 (e.g., in a periodic or otherwise ongoing basis).

In some embodiments, external devices 1454 may communicate with one or more elements of RAN 1410 and/or 1412 via an API or other suitable interface. For example, a given external device 1454 may provide instructions, requests, etc. to RAN 1410 and/or 1412 to provide one or more services via one or more respective MECs 1414. In some embodiments, such instructions, requests, etc. may include QoS parameters, Service Level Agreements (“SLAs”), etc. (e.g., maximum latency thresholds, minimum throughput thresholds, etc.) associated with the services.

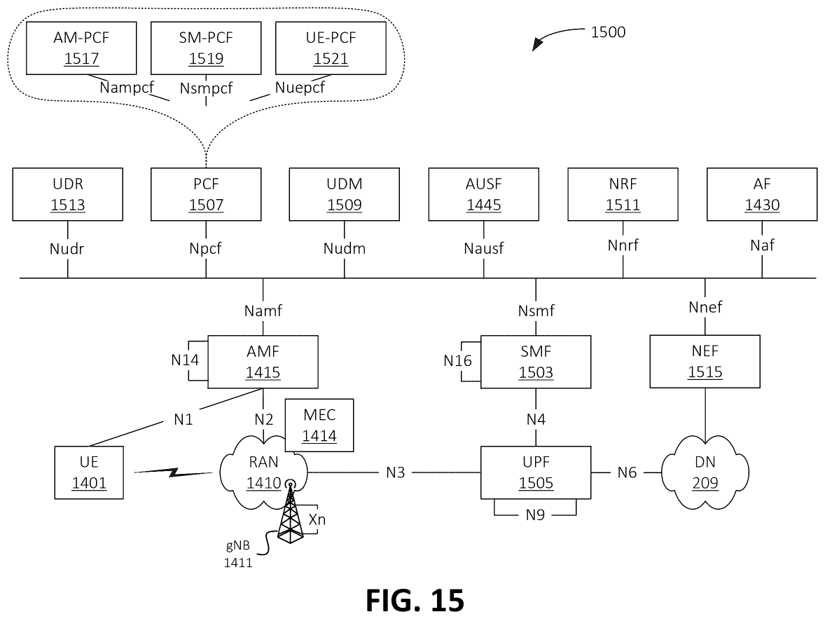

FIG. 15 illustrates another example environment 1500, in which one or more embodiments may be implemented. In some embodiments, environment 1500 may correspond to a 5G network, and/or may include elements of a 5G network. In some embodiments, environment 1500 may correspond to a 5G SA architecture. In some embodiments, environment 1500 may include a 5GC, in which 5GC network elements perform one or more operations described herein.

As shown, environment 1500 may include UE 1401, RAN 1410 (which may include one or more gNBs 1411 or other types of wireless network infrastructure) and various network functions, which may be implemented as VNFs, CNFs, etc. Such network functions may include AMF 1415, SMF 1503, UPF 1505, PCF 1507, UDM 1509, AUSF 1445, Network Repository Function (“NRF”) 1511, AF 1430, UDR 1513, and NEF 1515. Environment 1500 may also include or may be communicatively coupled to one or more networks, such as DN 209.

The example shown in FIG. 15 illustrates one instance of each network component or function (e.g., one instance of SMF 1503, UPF 1505, PCF 1507, UDM 1509, AUSF 1445, etc.). In practice, environment 1500 may include multiple instances of such components or functions. For example, in some embodiments, environment 1500 may include multiple “slices” of a core network, where each slice includes a discrete and/or logical set of network functions (e.g., one slice may include a first instance of SMF 1503, PCF 1507, UPF 1505, etc., while another slice may include a second instance of SMF 1503, PCF 1507, UPF 1505, etc.). Additionally, or alternatively, one or more of the network functions of environment 1500 may implement multiple network slices. The different slices may provide differentiated levels of service, such as service in accordance with different QoS parameters.

The quantity of devices and/or networks, illustrated in FIG. 15, is provided for explanatory purposes only. In practice, environment 1500 may include additional devices and/or networks, fewer devices and/or networks, different devices and/or networks, or differently arranged devices and/or networks than illustrated in FIG. 15. For example, while not shown, environment 1500 may include devices that facilitate or enable communication between various components shown in environment 1500, such as routers, modems, gateways, switches, hubs, etc. In some implementations, one or more devices of environment 1500 may be physically integrated in, and/or may be physically attached to, one or more other devices of environment 1500. Alternatively, or additionally, one or more of the devices of environment 1500 may perform one or more network functions described as being performed by another one or more of the devices of environment 1500.

Elements of environment 1500 may interconnect with each other and/or other devices via wired connections, wireless connections, or a combination of wired and wireless connections. Examples of interfaces or communication pathways between the elements of environment 1500, as shown in FIG. 15, may include interfaces shown in FIG. 15 and/or one or more interfaces not explicitly shown in FIG. 15. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 1500 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 1415), an Nudm interface (e.g., indicating communications to be routed to UDM 1509), an Npcf interface, an Nupf interface, an Nnef interface, an Nsmf interface, an Nnrf interface, an Nudr interface, an Naf interface, and/or one or more other SBIs.

UPF 1505 may include one or more devices, systems, VNFs, CNFs, etc., that receive, route, process, and/or forward traffic (e.g., user plane traffic). As discussed above, UPF 1505 may communicate with UE 1401 via one or more communication sessions, such as PDU sessions. Such PDU sessions may be associated with a particular network slice or other suitable QoS parameters, as noted above. UPF 1505 may receive downlink user plane traffic (e.g., voice call traffic, data traffic, etc. destined for UE 1401) from DN 209, and may forward the downlink user plane traffic toward UE 1401 (e.g., via RAN 1410). In some embodiments, multiple UPFs 1505 may be deployed (e.g., in different geographical locations), and the delivery of content to UE 1401 may be coordinated via the N9 interface. Similarly, UPF 1505 may receive uplink traffic from UE 1401 (e.g., via RAN 1410), and may forward the traffic toward DN 209. In some embodiments, UPF 1505 may implement, may be implemented by, may be communicatively coupled to, and/or may otherwise be associated with UPF/PGW-U 1435. In some embodiments, UPF 1505 may communicate (e.g., via the N4 interface) with SMF 1503, regarding user plane data processed by UPF 1505 (e.g., to provide analytics or reporting information, to receive policy and/or authorization information, etc.).

PCF 1507 may include one or more devices, systems, VNFs, CNFs, etc., that aggregate, derive, generate, etc. policy information associated with the 5GC and/or UEs 1401 that communicate via the 5GC and/or RAN 1410. PCF 1507 may receive information regarding policies and/or subscriptions from one or more sources, such as subscriber databases (e.g., UDM 1509, UDR 1513, etc.), and/or from one or more users such as, for example, an administrator associated with PCF 1507. In some embodiments, the functionality of PCF 1507 may be split into multiple network functions or subsystems, such as access and mobility PCF (“AM-PCF”) 1517, session management PCF (“SM-PCF”) 1519, UE PCF (“UE-PCF”) 1521, and so on. Such different “split” PCFs may be associated with respective SBIs (e.g., AM-PCF 1517 may be associated with an Nampcf SBI, SM-PCF 1519 may be associated with an Nsmpcf SBI, UE-PCF 1521 may be associated with an Nuepcf SBI, and so on) via which other network functions may communicate with the split PCFs. The split PCFs may maintain information regarding policies associated with different devices, systems, and/or network functions.

NRF 1511 may include one or more devices, systems, VNFs, CNFs, etc. that maintain routing and/or network topology information associated with the 5GC. For example, NRF 1511 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 1513 may include one or more devices, systems, VNFs, CNFs, etc. that provide user and/or subscriber information, based on which PCF 1507 and/or other elements of environment 1500 may determine access policies, QoS policies, charging policies, or the like. In some embodiments, UDR 1513 may receive such information from UDM 1509 and/or one or more other sources.

NEF 1515 include one or more devices, systems, VNFs, CNFs, etc. that provide access to information, APIs, and/or other operations or mechanisms of the 5GC to devices or systems that are external to the 5GC. NEF 1515 may maintain authorization and/or authentication information associated with such external devices or systems, such that NEF 1515 is able to provide information, that is authorized to be provided, to the external devices or systems. Such information may be received from other network functions of the 5GC (e.g., as authorized by an administrator or other suitable entity associated with the 5GC), such as SMF 1503, UPF 1505, a charging function (“CHF”) of the 5GC, and/or other suitable network function. NEF 1515 may communicate with external devices or systems (e.g., external devices 1454) via DN 209 and/or other suitable communication pathways.

While environment 1500 is described in the context of a 5GC, as noted above, environment 1500 may, in some embodiments, include or implement one or more other types of core networks. For example, in some embodiments, environment 1500 may be or may include a converged packet core, in which one or more elements may perform some or all of the functionality of one or more 5GC network functions and/or one or more EPC network functions. For example, in some embodiments, AMF 1415 may include, may implement, may be implemented by, and/or may otherwise be associated with MME 1416; SMF 1503 may include, may implement, may be implemented by, and/or may otherwise be associated with SGW 1417; PCF 1507 may include, may implement, may be implemented by, and/or may otherwise be associated with a PCRF (e.g., PCF/PCRF 1425); NEF 1515 may include, may implement, may be implemented by, and/or may otherwise be associated with a SCEF (e.g., NEF/SCEF 1449); and so on.

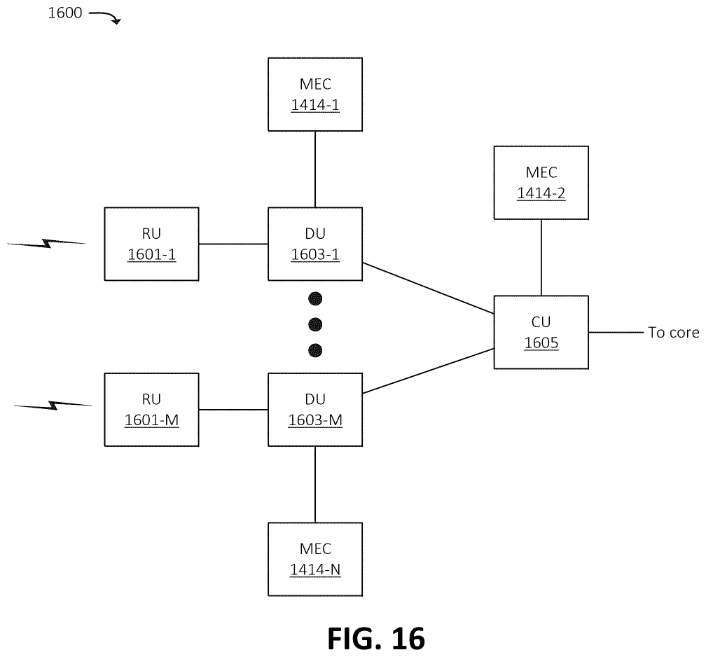

FIG. 16 illustrates an example RAN environment 1600, which may be included in and/or implemented by one or more RANs (e.g., RAN 1410 or some other RAN). In some embodiments, a particular RAN 1410 may include one RAN environment 1600. In some embodiments, a particular RAN 1410 may include multiple RAN environments 1600. In some embodiments, RAN environment 1600 may correspond to a particular gNB 1411 of RAN 1410. In some embodiments, RAN environment 1600 may correspond to multiple gNBs 1411. In some embodiments, RAN environment 1600 may correspond to one or more other types of base stations of one or more other types of RANs. As shown, RAN environment 1600 may include Central Unit (“CU”) 1605, one or more Distributed Units (“DUs”) 1603-1 through 1603-M (referred to individually as “DU 1603,” or collectively as “DUs 1603”), and one or more Radio Units (“RUs”) 1601-1 through 1601-M (referred to individually as “RU 1601,” or collectively as “RUs 1601”).

CU 1605 may communicate with a core of a wireless network (e.g., may communicate with one or more of the devices or systems described above with respect to FIG. 15, such as AMF 1415 and/or UPF 1505) and/or some other device or system such as MEC 1414. In the uplink direction (e.g., for traffic from UEs 1401 to a core network), CU 1605 may aggregate traffic from DUs 1603, and forward the aggregated traffic to the core network. In some embodiments, CU 1605 may receive traffic according to a given protocol (e.g., Radio Link Control (“RLC”) traffic) from DUs 1603, and may perform higher-layer processing (e.g., may aggregate/process RLC packets and generate Packet Data Convergence Protocol (“PDCP”) packets based on the RLC packets) on the traffic received from DUs 1603.

CU 1605 may receive downlink traffic (e.g., traffic from the core network, traffic from a given MEC 1414, etc.) for a particular UE 1401, and may determine which DU(s) 1603 should receive the downlink traffic. DU 1603 may include one or more devices that transmit traffic between a core network (e.g., via CU 1605) and UE 1401 (e.g., via a respective RU 1601). DU 1603 may, for example, receive traffic from RU 1601 at a first layer (e.g., physical (“PHY”) layer traffic, or lower PHY layer traffic), and may process/aggregate the traffic to a second layer (e.g., upper PHY and/or RLC). DU 1603 may receive traffic from CU 1605 at the second layer, may process the traffic to the first layer, and provide the processed traffic to a respective RU 1601 for transmission to UE 1401.

RU 1601 may include hardware circuitry (e.g., one or more RF transceivers, antennas, radios, and/or other suitable hardware) to communicate wirelessly (e.g., via an RF interface) with one or more UEs 1401, one or more other DUs 1603 (e.g., via RUs 1601 associated with DUs 1603), and/or any other suitable type of device. In the uplink direction, RU 1601 may receive traffic from UE 1401 and/or another DU 1603 via the RF interface and may provide the traffic to DU 1603. In the downlink direction, RU 1601 may receive traffic from DU 1603, and may provide the traffic to UE 1401 and/or another DU 1603.

One or more elements of RAN environment 1600 may, in some embodiments, be communicatively coupled to one or more MECs 1414. For example, DU 1603-1 may be communicatively coupled to MEC 1414-1, DU 1603-M may be communicatively coupled to MEC 1414-N, CU 1605 may be communicatively coupled to MEC 1414-2, and so on. MECs 1414 may include hardware resources (e.g., configurable or provisionable hardware resources) that may be configured to provide services and/or otherwise process traffic to and/or from UE 1401, via a respective RU 1601.

For example, DU 1603-1 may route some traffic, from UE 1401, to MEC 1414-1 instead of to a core network via CU 1605. MEC 1414-1 may process the traffic, perform one or more computations based on the received traffic, and may provide traffic to UE 1401 via RU 1601-1. As discussed above, MEC 1414 may include, and/or may implement, some or all of the functionality described above with respect to UPF 1505, AF 1430, and/or one or more other devices, systems, VNFs, CNFs, etc. In this manner, ultra-low latency services may be provided to UE 1401, as traffic does not need to traverse DU 1603, CU 1605, links between DU 1603 and CU 1605, and an intervening backhaul network between RAN environment 1600 and the core network.

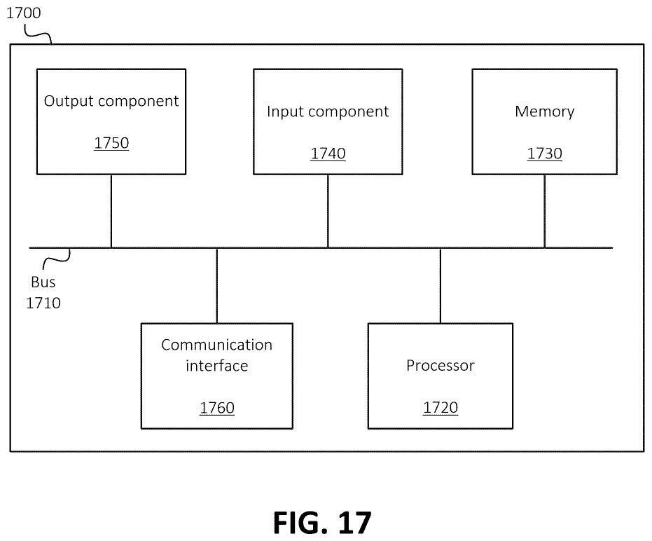

FIG. 17 illustrates example components of device 1700. One or more of the devices described above may include one or more devices 1700. Device 1700 may include bus 1710, processor 1720, memory 1730, input component 1740, output component 1750, and communication interface 1760. In another implementation, device 1700 may include additional, fewer, different, or differently arranged components.

Bus 1710 may include one or more communication paths that permit communication among the components of device 1700. Processor 1720 may include a processor, microprocessor, a set of provisioned hardware resources of a cloud computing system, a graphics processing unit (“GPU”), a GPU-based processing unit, a neural processing unit (“NPU”), or other suitable type of hardware that interprets and/or executes instructions (e.g., processor-executable instructions). In some embodiments, processor 1720 may be or may include one or more hardware processors. Memory 1730 may include any type of dynamic storage device that may store information and instructions for execution by processor 1720, and/or any type of non-volatile storage device that may store information for use by processor 1720.

Input component 1740 may include a mechanism that permits an operator to input information to device 1700 and/or other receives or detects input from a source external to input component 1740, such as a touchpad, a touchscreen, a keyboard, a keypad, a button, a switch, a microphone or other audio input component, etc. In some embodiments, input component 1740 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1750 may include a mechanism that outputs information to the operator, such as a display, a speaker, one or more light emitting diodes (“LEDs”), etc.

Communication interface 1760 may include any transceiver-like mechanism that enables device 1700 to communicate with other devices and/or systems (e.g., via RAN 1410, RAN 1412, DN 209, etc.). For example, communication interface 1760 may include an Ethernet interface, an optical interface, a coaxial interface, or the like. Communication interface 1760 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 1700 may include more than one communication interface 1760. For instance, device 1700 may include an optical interface, a wireless interface, an Ethernet interface, and/or one or more other interfaces.

Device 1700 may perform certain operations relating to one or more processes described above. Device 1700 may perform these operations in response to processor 1720 executing instructions, such as software instructions, processor-executable instructions, etc. stored in a computer-readable medium, such as memory 1730. A computer-readable medium may be defined as a non-transitory memory device. A memory device may include space within a single physical memory device or spread across multiple physical memory devices. The instructions may be read into memory 1730 from another computer-readable medium or from another device. The instructions stored in memory 1730 may be processor-executable instructions that cause processor 1720 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-13), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set. Concepts described above may be embodied by, for example, a device, devices, a system, systems, a method, methods, a non-transitory computer-readable medium, and/or non-transitory computer-readable media, as provided for in the claims.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
register a first Internet of Things (“IoT”) gateway that provides IoT device connectivity via a first access technology;
register a second IoT gateway that provides IoT device connectivity via a second access technology;
maintain information specifying a plurality of different IoT device onboarding procedures for different access technologies;
receive a first onboarding request, associated with a first IoT device;
determine that the first onboarding request is associated with the first IoT gateway;
determine, based on determining that the first onboarding request is associated with the first IoT gateway, that a first IoT device onboarding procedure, of the plurality of onboarding procedures, should be performed for the first IoT device;
perform the first IoT device onboarding procedure to onboard the first IoT device;
receive a second onboarding request, associated with a second IoT device;
determine that the second onboarding request is associated with the second IoT gateway;
determine, based on determining that the second onboarding request is associated with the second IoT gateway, that a second IoT device onboarding procedure, of the plurality of IoT device onboarding procedures, should be performed for the second IoT device, wherein the second IoT device onboarding procedure is different from the first IoT device onboarding procedure;
perform the second IoT device onboarding procedure to onboard the second IoT device; and
receive, based on onboarding the first and second IoT devices, first IoT uplink information from the first IoT device and second IoT uplink information from the second IoT device.

2. The device of claim 1, wherein the one or more processors are further configured to:
register a third IoT gateway that provides IoT device connectivity via a third access technology;
receive a third onboarding request, associated with a third IoT device;
determine that the third onboarding request is associated with the third IoT gateway;
determine, based on determining that the third onboarding request is associated with the third IoT gateway, that a third IoT device onboarding procedure, of the plurality of IoT device onboarding procedures, should be performed for the third IoT device, wherein the third IoT device onboarding procedure is different from the first and second IoT device onboarding procedures;
perform the third IoT device onboarding procedure to onboard the third IoT device; and
receive, based on onboarding the third IoT device, third IoT uplink information from the third IoT device.

3. The device of claim 1,
wherein the first IoT device onboarding procedure includes one of:
a manual IoT device onboarding procedure,
a semi-automatic IoT device onboarding procedure, or
an automatic IoT device onboarding procedure, and
wherein the second IoT device onboarding procedure includes a different one of:
the manual IoT device onboarding procedure,
the a semi-automatic IoT device onboarding procedure, or
the automatic IoT device onboarding procedure.

4. The device of claim 1,
wherein the first access technology includes one of:
a Long Range Wide Area Network (“LoRaWAN”) access technology,
a Bluetooth Low Energy (“BLE”) access technology, or
an IO-Link access technology, and
wherein the second IoT device onboarding procedure includes a different one of:
the LoRaWAN access technology,
the BLE access technology, or
the IO-Link access technology.

5. The device of claim 1, wherein the first access technology includes a wireless access technology, and wherein the second access technology includes a wired access technology.

6. The device of claim 1, wherein the first onboarding requests includes an identifier of the first IoT gateway, wherein determining that the first onboarding request is associated with the first IoT gateway is based on identifier included in the first onboarding request.

7. The device of claim 1, wherein the first gateway and the second gateway further communicate with a radio access network (“RAN”) of a wireless network, wherein receiving the first and second IoT uplink information includes receiving the first and second IoT uplink information via the RAN of the wireless network.

8. A non-transitory computer-readable medium, storing a plurality of processor-executable instructions to:
register a first Internet of Things (“IoT”) gateway that provides IoT device connectivity via a first access technology;
register a second IoT gateway that provides IoT device connectivity via a second access technology;
maintain information specifying a plurality of different IoT device onboarding procedures for different access technologies;
receive a first onboarding request, associated with a first IoT device;
determine that the first onboarding request is associated with the first IoT gateway;
determine, based on determining that the first onboarding request is associated with the first IoT gateway, that a first IoT device onboarding procedure, of the plurality of onboarding procedures, should be performed for the first IoT device;
perform the first IoT device onboarding procedure to onboard the first IoT device;
receive a second onboarding request, associated with a second IoT device;
determine that the second onboarding request is associated with the second IoT gateway;
determine, based on determining that the second onboarding request is associated with the second IoT gateway, that a second IoT device onboarding procedure, of the plurality of IoT device onboarding procedures, should be performed for the second IoT device, wherein the second IoT device onboarding procedure is different from the first IoT device onboarding procedure;
perform the second IoT device onboarding procedure to onboard the second IoT device; and
receive, based on onboarding the first and second IoT devices, first IoT uplink information from the first IoT device and second IoT uplink information from the second IoT device.

9. The non-transitory computer-readable medium of claim 8, wherein the plurality of processor-executable instructions further include processor-executable instructions to:
register a third IoT gateway that provides IoT device connectivity via a third access technology;
receive a third onboarding request, associated with a third IoT device;
determine that the third onboarding request is associated with the third IoT gateway;
determine, based on determining that the third onboarding request is associated with the third IoT gateway, that a third IoT device onboarding procedure, of the plurality of IoT device onboarding procedures, should be performed for the third IoT device, wherein the third IoT device onboarding procedure is different from the first and second IoT device onboarding procedures;
perform the third IoT device onboarding procedure to onboard the third IoT device; and
receive, based on onboarding the third IoT device, third IoT uplink information from the third IoT device.

10. The non-transitory computer-readable medium of claim 8,
wherein the first IoT device onboarding procedure includes one of:
a manual IoT device onboarding procedure,
a semi-automatic IoT device onboarding procedure, or
an automatic IoT device onboarding procedure, and
wherein the second IoT device onboarding procedure includes a different one of:
the manual IoT device onboarding procedure,
the a semi-automatic IoT device onboarding procedure, or
the automatic IoT device onboarding procedure.

11. The non-transitory computer-readable medium of claim 8,
wherein the first access technology includes one of:
a Long Range Wide Area Network (“LoRaWAN”) access technology,
a Bluetooth Low Energy (“BLE”) access technology, or
an IO-Link access technology, and
wherein the second IoT device onboarding procedure includes a different one of:
the LoRaWAN access technology,
the BLE access technology, or
the IO-Link access technology.

12. The non-transitory computer-readable medium of claim 8, wherein the first access technology includes a wireless access technology, and wherein the second access technology includes a wired access technology.

13. The non-transitory computer-readable medium of claim 8, wherein the first onboarding requests includes an identifier of the first IoT gateway, wherein determining that the first onboarding request is associated with the first IoT gateway is based on identifier included in the first onboarding request.

14. The non-transitory computer-readable medium of claim 8, wherein the first gateway and the second gateway further communicate with a radio access network (“RAN”) of a wireless network, wherein receiving the first and second IoT uplink information includes receiving the first and second IoT uplink information via the RAN of the wireless network.

15. A method, comprising:
registering a first Internet of Things (“IoT”) gateway that provides IoT device connectivity via a first access technology;
registering a second IoT gateway that provides IoT device connectivity via a second access technology;
maintaining information specifying a plurality of different IoT device onboarding procedures for different access technologies;
receiving a first onboarding request, associated with a first IoT device;
determining that the first onboarding request is associated with the first IoT gateway;
determining, based on determining that the first onboarding request is associated with the first IoT gateway, that a first IoT device onboarding procedure, of the plurality of onboarding procedures, should be performed for the first IoT device;
performing the first IoT device onboarding procedure to onboard the first IoT device;
receiving a second onboarding request, associated with a second IoT device;
determining that the second onboarding request is associated with the second IoT gateway;
determining, based on determining that the second onboarding request is associated with the second IoT gateway, that a second IoT device onboarding procedure, of the plurality of IoT device onboarding procedures, should be performed for the second IoT device, wherein the second IoT device onboarding procedure is different from the first IoT device onboarding procedure;
performing the second IoT device onboarding procedure to onboard the second IoT device; and
receiving, based on onboarding the first and second IoT devices, first IoT uplink information from the first IoT device and second IoT uplink information from the second IoT device.

16. The method of claim 15, further comprising:
registering a third IoT gateway that provides IoT device connectivity via a third access technology;
receiving a third onboarding request, associated with a third IoT device;
determining that the third onboarding request is associated with the third IoT gateway;
determining, based on determining that the third onboarding request is associated with the third IoT gateway, that a third IoT device onboarding procedure, of the plurality of IoT device onboarding procedures, should be performed for the third IoT device, wherein the third IoT device onboarding procedure is different from the first and second IoT device onboarding procedures;
performing the third IoT device onboarding procedure to onboard the third IoT device; and
receiving, based on onboarding the third IoT device, third IoT uplink information from the third IoT device.

17. The method of claim 15,
wherein the first IoT device onboarding procedure includes one of:
a manual IoT device onboarding procedure,
a semi-automatic IoT device onboarding procedure, or
an automatic IoT device onboarding procedure, and
wherein the second IoT device onboarding procedure includes a different one of:
the manual IoT device onboarding procedure,
the a semi-automatic IoT device onboarding procedure, or
the automatic IoT device onboarding procedure.

18. The method of claim 15,
wherein the first access technology includes one of:
a Long Range Wide Area Network (“LoRaWAN”) access technology,
a Bluetooth Low Energy (“BLE”) access technology, or
an IO-Link access technology, and
wherein the second IoT device onboarding procedure includes a different one of:
the LoRaWAN access technology,
the BLE access technology, or
the IO-Link access technology.

19. The method of claim 15, wherein the first access technology includes a wireless access technology, and wherein the second access technology includes a wired access technology.

20. The method of claim 15, wherein the first onboarding requests includes an identifier of the first IoT gateway, wherein determining that the first onboarding request is associated with the first IoT gateway is based on identifier included in the first onboarding request.
